(19) United States
(12) Patent Application Publication
(10) Pub. No.: US 2002/0118967 A1
(43) Pub. Date: Aug. 29, 2002

(54) Color correcting flash apparatus, camera, and method

(76) Inventor: David L. Funston, Batavia, NY (US)

Correspondence Address: Milton S. Sales, Paten Legal Staff, Eastman Kodak Company, 343 State Street, Rochester, NY, 14650-2201, US

(21) Appl. No.: 09/747,714

(22) Filed: Dec. 22, 2000

(51) Int. Cl. G03B 15/03

(52) U.S. Cl. 396/155

(57) ABSTRACT

A photographic apparatus, camera, and method are used in ambient light with an archival capture media having a designated illuminant. The apparatus includes a body and an ambient light discriminator mounted in the body. The discriminator assesses a color value of ambient light. A flash firing circuit is disposed in the body. An operation circuit operatively connects the ambient light discriminator and flash firing circuit. The flash firing circuit arms responsive to a mismatch between the color value and the designated illuminant.

### CROSS REFERENCE TO RELATED APPLICATIONS

Reference is made to commonly assigned co-pending U.S. patent applications Ser. No. ______, entitled: HYBRID CAMERA FILL-FLASH, and filed in the names of Hirohiko Ina and Hisanori Hoshikawa; Ser. No. ______, entitled: CAMERA HAVING VERIFICATION DISPLAY WITH VIEWER ADAPTATION COMPENSATION FOR REFERENCE ILLUMUNANTS AND METHOD, and filed in the names of David L. Funston and Kenneth A. Parulski; Ser. No. ______, entitled: CAMERA HAVING VERIFICATION DISPLAY AND WHITE-COMPENSATOR AND IMAGING METHOD, and filed in the name of Kenneth A. Parulski; Ser. No. ______, entitled: CAMERA HAVING USER INTERFACE WITH VERIFICATION DISPLAY AND COLOR CAST INDICATOR, and filed in the names of David L. Funston, Kenneth A. Parulski, and Robert Luke Walker; Ser. No. ______, entitled: CAMERA HAVING VERIFICATION DISPLAY WITH REVERSE WHITE BALANCED VIEWER ADAPTATION COMPENSATION AND METHOD, and filed in the names of Kenneth A. Parulski and David L. Funston; Ser. No. ______, entitled: CAMERA HAVING USER INTERFACE AMBIENT SENSOR VIEWER ADAPTATION COMPENSATION AND METHOD, and filed in the name of Kenneth A. Parulski; Ser. No. ______, entitled: CAMERA THAT DISPLAYS PREDOMINANT COLOR OF MULTI-COLOR SCENE AND/OR MULTI-COLOR CAPTURED IMAGE OF SCENE, and filed in the name of Roger A. Fields, and Ser. No. 08/970,327 filed Nov. 14, 1997, and filed in the names of James R. Niederbaumer and Michael Eugene Miller.

### FIELD OF THE INVENTION

The invention relates to photography and photographic equipment and more particularly relates to a color correcting flash apparatus, camera and method.

### BACKGROUND OF THE INVENTION

The color balance of latent photographic images depends on the spectral power distribution, that is, the color temperature, of the scene illuminant. The term “color temperature” and like terms are used herein in a sense that encompasses both actual color temperatures and correlated color temperatures. The definition of “correlated color temperature” in The Focal Encyclopedia of Photography, 3rd ed., Stroebel, L. and Zakia, R., ed., Focal Press, Boston, 1993, page 175, states:

“CORRELATED COLOR TEMPERATURE A value assigned to a light source that does not approximate a black body source and therefore does not possess a color temperature. The correlated color temperature is the color temperature of the blackbody source that most closely approximates the color quality of the source in question. Correlated color temperatures are determined by illuminating selected color samples with the source in question and then determining the color temperature of the blackbody source that results in the color samples appearing the most similar to a standard observer.”

The color balance of latent photographic images also depends on the type of film used. A film of a given type is formulated to provide a neutral response to a particular designated illuminant. A neutral response matches the spectral power distribution of the designated illuminant. For example, “daylight” film directly exposed by daylight records equal printing densities for each of the cyan, yellow, and magenta film records. A resulting photographic print, photofinished so as to maintain the neutral response, will be properly color balanced with white objects in the scene appearing as white objects in the printed image.

If a film of a given type is exposed using an illuminant that has a different color balance than the designated illuminant for that film type, then the resulting final images will have a color cast, that is, a non-neutral response in the form of a color balance shift that causes white objects in the scene to appear colored. For example, a color cast in a photographic print means that white objects in the scene are reproduced at a noticeably different correlated color temperature than that of a “white” illuminant used to illuminate the print. The color cast can be described in terms of the perceived color that replaces white. With daylight film, fluorescent exposures printed neutrally (that is, with the same printed balance as used for daylight exposures) result in images having a greenish color cast when viewed in daylight; tungsten exposures have a reddish-orange color cast.

The color balance of a final photographic image produced by photofinishing also depends upon the scene balance algorithm used to control the photographic printer or other photofinishing equipment used. Many commercially available photofinishing systems attempt to determine the color balance of photographic images before printing to allow compensation for a color cast caused by fluorescent (and tungsten) illumination. The compensation is typically only partial, because partial compensation does not unacceptably degrade highly-colored images (for example, images of bright yellow objects under daylight illumination) that are erroneously judged as having a different illuminant and selected for color compensation. A noticeable color cast is still perceived in the final images, after the partial compensation. Stating this another way, after partial compensation, white objects in the scene shown in final photofinished images are perceived as being non-white in color. This color cast can provide an artistic effect, but in most cases, the remaining color cast is objectionable to the user.

In some digital still and video cameras, this problem with color cast is not present, since the final image is produced from a saved image data set that has been subjected to white balancing. Such images have a neutral color balance when output to an appropriately configured output device. Methods for calibrating to particular devices and media are well known. Many white balancing procedures are known. For example, one method of white balancing is described in U.S. Pat. No. 5,659,357, “Auto white adjusting device”, to Miyano. The result of this process is that the red (R) and blue (B) code values of the digital images captured using various illuminants are scaled by appropriate white balance correction parameters. These parameters are determined such that the white balance corrected R and B codes are approximately equal to the green (G) codes for white and neutral gray objects of the scene.

The human visual system, under common lighting conditions, adapts to illuminants having different color temperatures, in a manner that is similar to the white balancing just discussed. (The terms “visual adaptation” and “adaptation” are used herein in the sense of chromatic adaptation. Brightness adaptation is only included to the extent that brightness effects influence chromatic adaptation.) The result is that daylight, fluorescent, tungsten, and some other illuminants, in isolation, are all perceived as white illumination. As noted above, photographic film does not function in the same manner as the human visual system; and after photofinishing, pictures photographed in some lighting conditions are perceived as having a color cast. The viewer perceives the pictures, as if through a colored filter.

Daylight type photographic film is color balanced for use with daylight or with electronic flash. Thus an unacceptable color cast is not present when an electronic flash is used as the scene illuminant or is used in combination with daylight illumination. Some film cameras are set up to provide electronic flash illumination for every exposure. Used outdoors, the flash illumination is overwhelmed by or combines with daylight illumination. Indoors, in ordinary use, the flash illumination is the dominant illuminant within the range of the flash unit. The continuous flash also has the shortcoming of draining batteries rapidly and being a distraction in some uses. Many cameras automatically provide electronic flash whenever available light is too dim for adequate film exposure. With photograpically fast films and common indoor lighting intensities, these cameras do not find the intensity of the available light inadequate and thus do not automatically flash. Resulting images have adequate light exposure; but, with daylight film, will have a color cast if exposed under common indoor illuminants.

U.S. patent application Ser. No. 08/970,327, filed by Miller, M. et al., entitled, “Automatic Luminance and Contrast Adjustment for Display Device”, which is commonly assigned with this application; teaches a camera which measures the ambient light level and adjusts the brightness and contrast of an image display on the camera.

It would thus be desirable to provide an improved apparatus, camera, and method in which color casts on photographed images can be avoided by usage of a flash unit that flashes automatically, but not continuously.

### SUMMARY OF THE INVENTION

The invention is defined by the claims. The invention, in its broader aspects, provides a photographic apparatus for use in ambient light with an archival capture media having a designated illuminant and a camera and method. The apparatus includes a body and an ambient light discriminator mounted in the body. The discriminator assesses a color value of ambient light. A flash firing circuit is disposed in the body. An operation circuit operatively connects the ambient light discriminator and flash firing circuit. The flash firing circuit arms responsive to a mismatch between the color value and the designated illuminant.

It is an advantageous effect of at least some of the embodiments of the invention that an improved apparatus, camera, and method are provided in which color casts on photographed images can be avoided by usage of a flash unit that flashes automatically, but not continuously.

### BRIEF DESCRIPTION OF THE DRAWINGS

The above-mentioned and other features and objects of this invention and the manner of attaining them will become more apparent and the invention itself will be better understood by reference to the following description of an embodiment of the invention taken in conjunction with the accompanying figures wherein:

FIG. 1 is a diagram of an embodiment of the method system.

FIG. 2 is a diagram of the overall operation of the camera of FIG. 1.

FIG. 3 is a schematic diagram of an embodiment of the camera.

FIG. 4 is a schematic diagram of another embodiment of the camera.

FIG. 5 is a schematic diagram of another embodiment of the camera.

FIG. 6 is a rear perspective view of the camera of FIG. 3.

FIG. 7 is a partially exploded view of the camera of FIG. 3.

FIG. 8 is a partial diagrammatical view of an embodiment of the camera showing details of an ambient light detector that is separate from the imager.

FIG. 9 is a flow chart of secondary approaches.

FIG. 10 is a simplified schematic diagram of an embodiment of the camera.

FIG. 11 is a simplified schematic diagram of an embodiment of the diagram of the camera.

FIG. 12 is a flow chart of the operation of the camera of FIG. 10.

FIG. 13 is a simplified schematic diagram of another embodiment of the camera.

FIG. 14 is a detailed schematic of the color balancing circuit of the camera of FIG. 13.

FIG. 15 is a diagram of the division of the electronic image into blocks for the white balancing of the camera of FIG. 13.

FIG. 16 is a diagram of the brightest block signal area in the DG-DI plane for the white balancing of the camera of FIG. 13.

### DETAILED DESCRIPTION OF THE INVENTION

In the method of the invention, a camera assesses a color value of ambient light and arms a flash firing circuit when the color value is outside a predetermined color value range.

The term “color value” used herein refers to a set of properties which defines a particular color stimulus in one or more multiple color systems. The stimulus has a particular continuous or discontinuous range in the system or systems. This range can be specifically mentioned, as in “a range of color values” or can be omitted, as in “a color value”, without a change in the scope of the terms. Each of the color systems has a known set of multiple reference color stimuli and a reference detector or observer having known responsivities. Thus, a particular color stimulus has a corresponding set of defining reference color stimulus values for each color system. To reduce required calculations, it is very highly preferred that the color systems are each trichromatic and, thus, that the defining reference color stimulus values are tristimulus values. The color system or systems, in which a color value defines a particular color stimulus, can be based upon a human visual standard, such as a CIE standard observer, but are not limited to a human visual standard. Correlated color temperatures are color values. A color value can include a calibration, for a color system that is not based upon a human visual standard, to account for human visual metamerism. Such a calibration can also be provided separately from color values. The relevant color system or systems for a particular use of the term “color value” is defined by the context. For example, an average color value for a display is an average of red, green, and blue (RGB) intensities and likewise a chromaticity, that is, an average of chromaticity coordinates for a particular human standard. For convenience, color value is generally discussed herein in relation to embodiments in which visual metamerism is not problematic and color value is the same as chromaticity. Specific terminology related to chromaticity has been avoided. For example, the term “color detector” is used to broadly define a color measuring or assessing device, instead of the term “calorimeter”; since a “colorimeter” is a color detector that measures chromaticities. Archival capture media is matched to, that is, color balanced for use with, a designated illuminant having a particular color value. The color value can be expressed as the correlated color temperature of the designated illuminant.

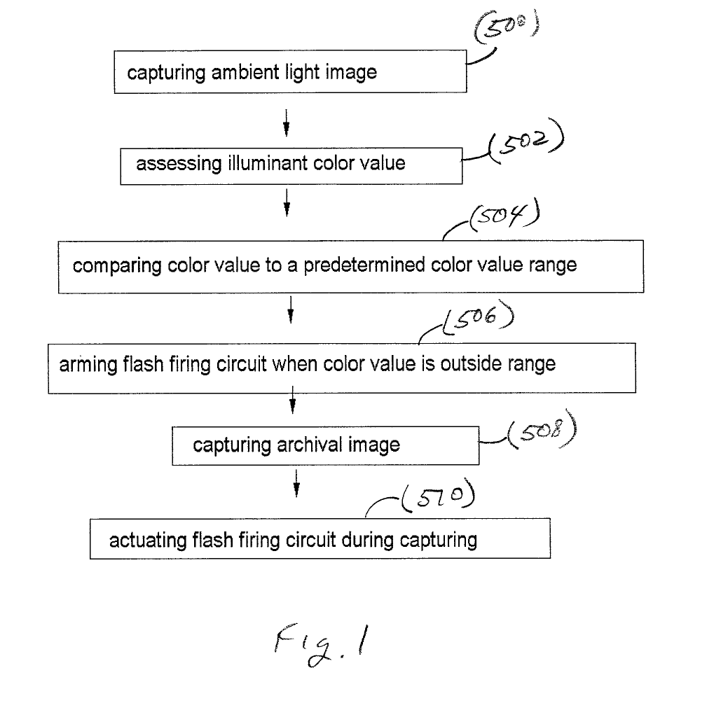

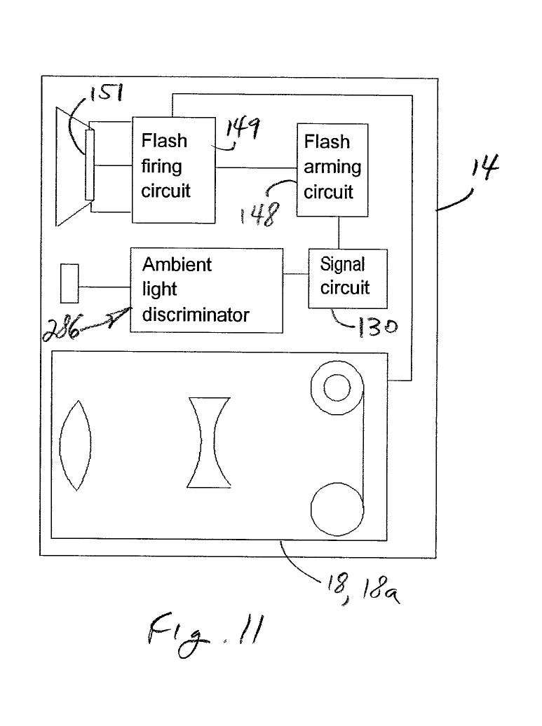

Referring to FIGS. 1 and 11, a photographer aims a camera 14 at a scene and starts the picture taking process. The scene illuminant color value of the ambient light is assessed (502) and then compared (504) to a predetermined color value range and a flash status signal is transmitted by an ambient light discriminator 286 and operation circuit or signal circuit 130. In a particular embodiment, an ambient light image is captured (500) as an electronic image in a camera as a part of this assessing (502). The flash status signal is received by a flash arming circuit 148, which arms (506) a flash firing circuit 149 responsive to the signal, when the scene illuminant color value is outside the predetermined color value range. An archival image is captured (508) by an archival capture unit 18, following the arming. The flash firing circuit 149 is actuated (510) during the capturing to fire a flash tube 151. The captured archival image is illuminated by light from the flash unit. That light is within the predetermined color value range.

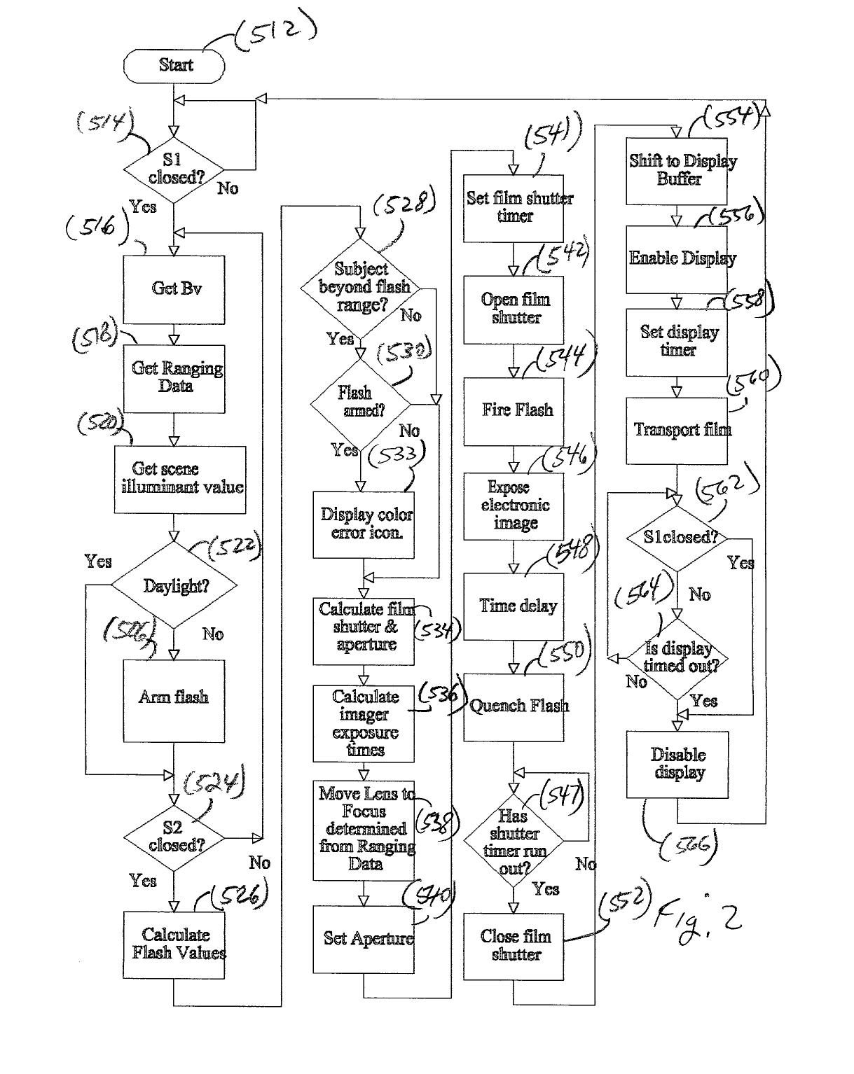

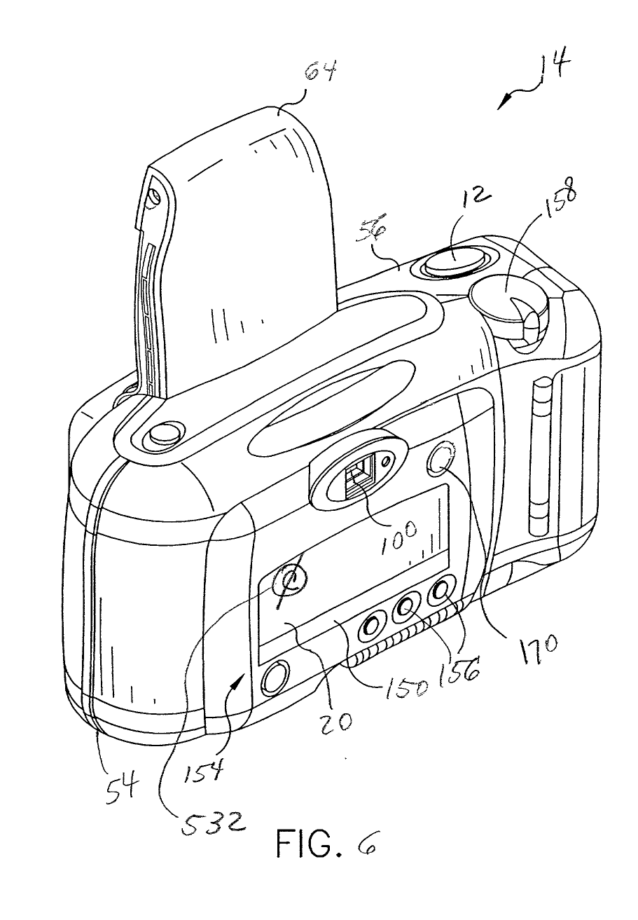

A broader overview of the operation of this embodiment the camera is illustrated in FIG. 2. The user starts (512) the process by aiming the camera and pressing the shutter release to a first position, in which a switch S1 closes. The camera tests (514) for closure of S1, and, if found, gets (516) brightness (also referred to here as “luminance” or “Bv”) data, gets (518) ranging data, and gets (520) scene illuminant color value data. The camera tests (522) for whether the scene illuminant color value represents daylight in terms of both color value and brightness. If so, a flash arming circuit is retained in standby mode. If color value does not match the predetermined color value of “daylight”, or if brightness is below a minimum level, or both; then the flash arming circuit is armed (506) by the operation circuit. The camera tests (524) for closure of switch S2 upon further depression of the shutter release and when switch S2 closes, calculates (526) flash values. The camera tests (528) if the subject (as indicated by the ranging data) is beyond flash range and, if so, tests (530) whether the flash is armed. If this is the case, then the camera cannot correct color by use of the flash (since the subject is out of range) and a color error icon 532 (shown in FIG. 6) or other indicia is shown (533) to inform the user of the problem. If this is not the case, then the camera calculates (534) values for a film shutter and aperture, and calculates (536) the equivalents for the electronic imager. The camera moves (538) the lens system to the focus position determined by ranging data, and sets (540, 541) the apertures and timers. The camera opens (542) the film shutter, fires (544) the flash and exposes (546) the electronic image. The film shutter is retained (547) open. After the calculated film times have elapsed (548), the flash is quenched (550) and the shutter is closed (552). The captured electronic image is shifted (554) to a display memory buffer, display (556) is enabled, and a timer is set (558) for ending the display. Film is archival media in this embodiment and the film is transported (560). The displaying of the electronic image ceases (566) with closure (562) of switch S1 or timing out (564).

The method is suitable for film cameras and for digital cameras that record images on media having a predetermined white point, without white balancing to correct the color cast of ambient lighting. The method is particularly advantageous for hybrid cameras that present a verification image to the user along with recording a film or electronic archival image, since problems of matching the verification image and the archival image under many difficult lighting conditions are resolved by providing flash illumination. Cameras are generally able to accommodate excessive illumination without difficulty. For example, with cameras using many types of photographic film as archival media, even if the shutter and diaphragm adjustments are exceeded, there is broad overexposure latitude.

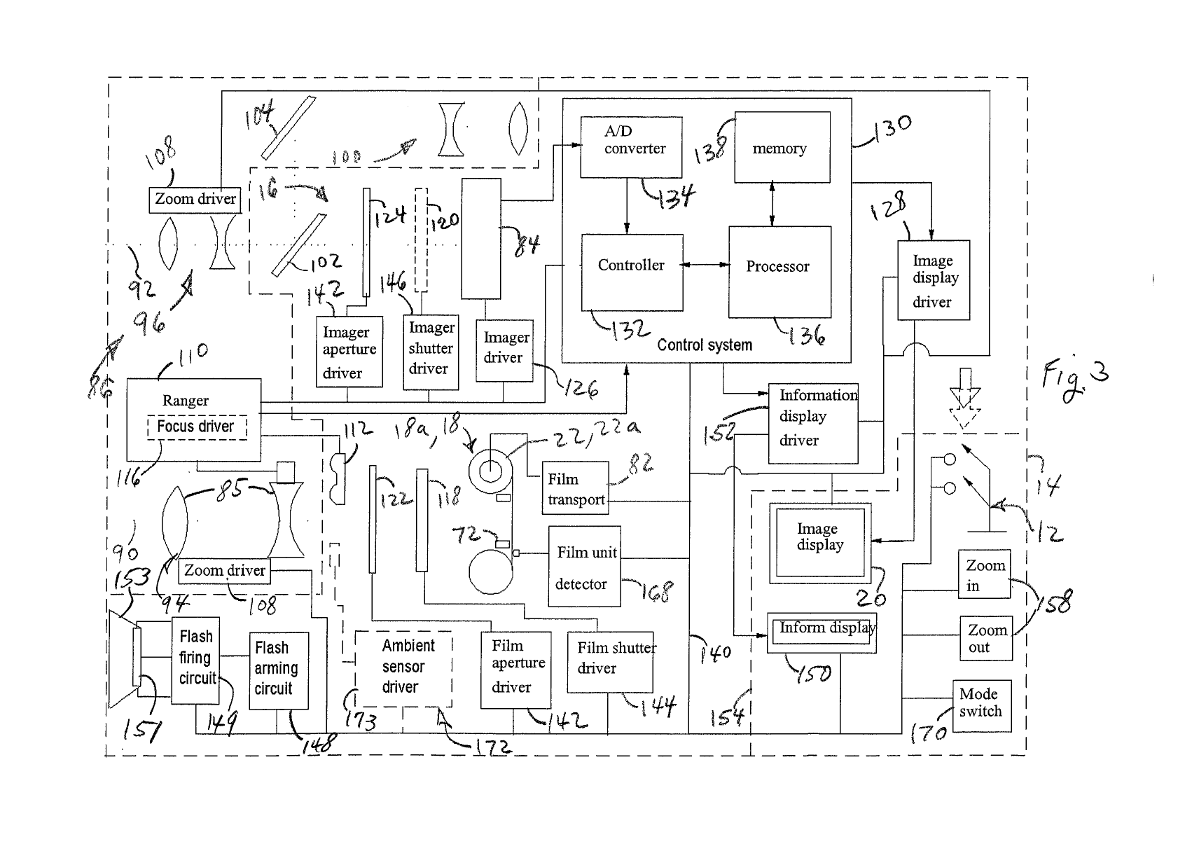

Cameras 14 are shown in FIGS. 3-7. For convenience, the cameras 14 are generally discussed in reference to the embodiment shown in FIGS. 3 and 6-7. Like considerations apply to the cameras 14 shown in the other figures and to cameras generally.

Referring to FIGS. 3, 6, and 7, the camera 14, in this embodiment, has a body 54 that holds a film latent image capture unit 18a and an electronic capture unit 16. The body 54 provides structural support and protection for other components. The body 54 of the camera 14 can be varied to meet requirements of a particular use and style considerations. It is convenient if the body 54 has front and rear covers 56, 58 joined together over a chassis 60. Many of the components of the camera 14 can be mounted to the chassis 60. A film door 62 and a flip-up flash unit 64 are pivotably joined to the covers 56, 58 and chassis 60.

The archival image capture unit 18 mounted in the body 54 is a film capture unit 18a. The film capture unit 18a has a film holder 66 that holds a film unit 42 during use. The configuration of the film holder 66 is a function of the type of film unit 42 used. The camera 14 shown in the Figures is film reloadable and uses an Advanced Photo System (“APS”) film cartridge. The camera 14 has IX-DX code reader (not shown) to determine the film type and a magnetic writer (not shown) to write data on the film 22a indicating how many prints of each film frame to produce. This is not limiting. For example, other types of one or two chamber film cartridge, and roll film; and suitable cameras, can also be used.

The film holder 66 includes a pair of film chambers 68, 70 and an exposure frame 72 (sometimes referred to as an “intermediate section”) between the film chambers 68, 70. The film unit 42 has a canister 74 disposed in one of the chambers. A filmstrip 22a is wound around a spool held by the canister 74. During use, the filmstrip 22a extends across the exposure frame 72 and is wound into a film roll 76 in the other chamber. The exposure frame 72 has an opening 78 through which a light image exposes a frame 80 of the film 22a at each picture taking event.

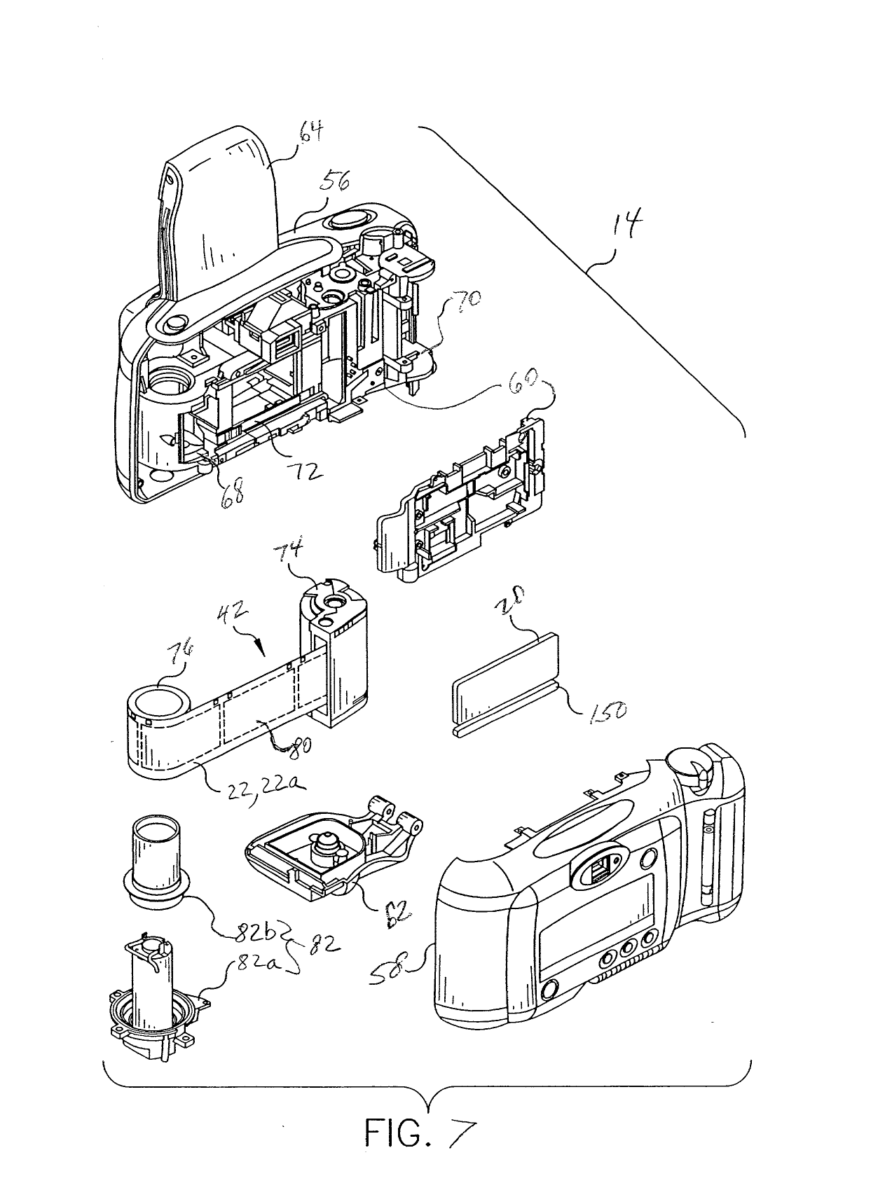

The filmstrip 22a is moved across the exposure frame 72 by a film transport 82. The film transport 82, as illustrated in FIG. 7, includes an electric motor 82a located within a supply spool 82b, but other types of motorized transport mechanisms and manual transports can also be used. Latent image exposure can be on film advance or on rewind.

The electronic image capture unit 16 has an electronic array imager 84 that is mounted in the body 54 and is configured so as to capture the same scene as is captured in the latent image on film. The type of imager 84 used may vary, but it is highly preferred that the imager 84 be one of the several solid-state imagers available. One highly popular type of solid-state imager commonly used is the charge coupled device (“CCD”). Of the several CCD types available, two allow easy electronic shuttering and thereby are preferable in this use. The first of these, the frame transfer CCD, allows charge generation due to photoactivity and then shifts all of the image charge into a light shielded, non-photosensitive area. This area is then clocked out to provide a sampled electronic image. The second type, the interline transfer CCD, also performs shuttering by shifting the charge, but shifts charge to an area above or below each image line so that there are as many storage areas as there are imaging lines. The storage lines are then shifted out in an appropriate manner. Each of these CCD imagers has both advantages and disadvantages, but all will work in this application. A typical CCD has separate components that act as clock drivers, analog signal processor 136 (ASP) and A/D converter. It is also possible to use an electronic image sensor manufactured with CMOS technology. This type of imager is attractive for use, since it is manufactured easily in a readily available solid-state process and lends itself to use with a single power supply. In addition, the process allows peripheral circuitry to be integrated onto the same semiconductor die. For example, a CMOS sensor can include clock drivers, analog signal processor 136 and A/D converter components integrated on a single IC. A third type of sensor which can be used is a charge injection device (CID). This sensor differs from the others mentioned in that the charge is not shifted out of the device to be read. Reading is accomplished by shifting charge within the pixel. This allows a nondestructive read of any pixel in the array. If the device is externally shuttered, the array can be read repeatedly without destroying the image. Shuttering can be accomplished by external shutter or, without an external shutter, by injecting the charge into the substrate for recombination.

The electronic image capture unit 16 captures a three-color image. It is highly preferred that a single imager 84 be used along with a three-color filter, however, multiple monochromatic imagers and filters can be used. Suitable three-color filters are well known to those of skill in the art, and, in some cases are incorporated with the imager 84 to provide an integral component.

Referring now primarily to FIG. 3, the camera 14 has a optical system 86 of one or more lenses mounted in the body 54. The optical system is illustrated by a dashed line and several groups of lens elements 85. It will be understood that this is illustrative, not limiting. The optical system 86 directs light to the exposure frame 72 and to the electronic array imager 84. The optical system 86 also preferably directs light through a viewfinder 88 to the user, as shown in FIG. 3. The imager 84 is spaced from the exposure frame 72, thus, the optical system 86 directs light along the first path (indicated by a dotted line 90) to the exposure frame 72 and along a second path (indicated by a dotted line 92) to the electronic array imager 84. Both paths 90, 92 converge at a position in front of the camera 14, at the plane of the subject image. In FIG. 3, the optical system 86 has first and second paths 90, 92 that are in convergence at the subject image and extend to a taking lens unit 94 and a combined lens unit 96 that includes both an imager lens unit 98 and a viewfinder lens unit 100. The combined lens unit 96 has a partially transmissive mirror 102 that subdivides the second light path 92 between an imager subpath 92a to the imager 84 and a viewfinder subpath 92b that is redirected by a fully reflective mirror 104 and transmitted through an eyepiece 106 to the photographer.

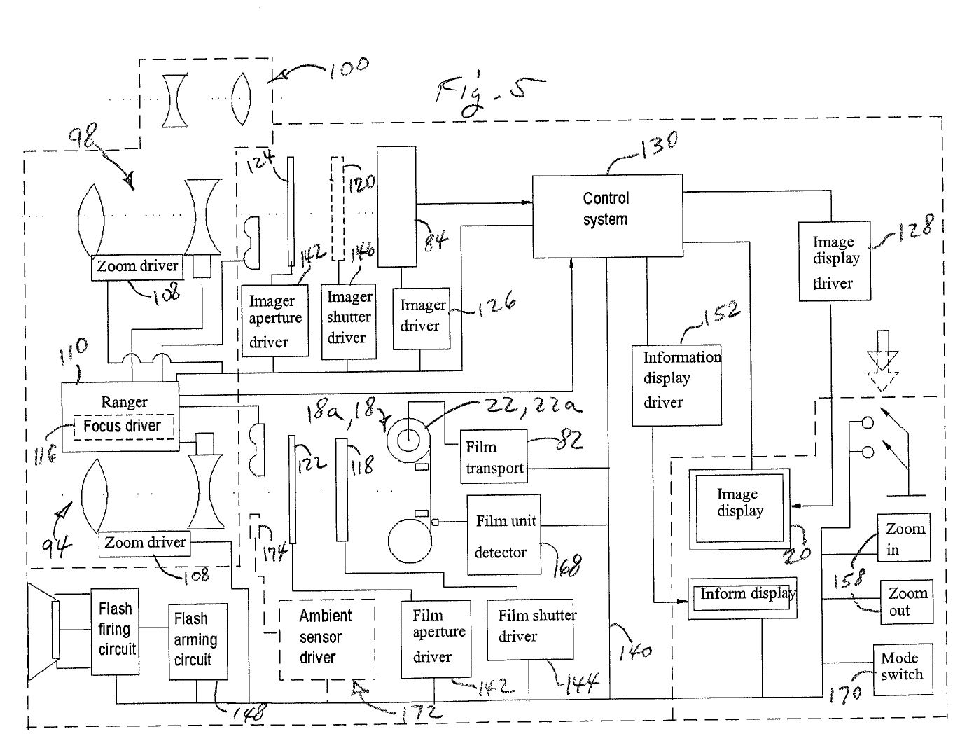

The optical system 86 can be varied. A viewfinder lens unit and an imager lens unit can be fully separate, as shown in FIG. 5, or a combined lens unit can includes both a taking lens unit and an imager lens unit (not shown). Other alternative optical systems can also be provided.

Referring again to the embodiment shown in FIG. 3, the taking lens unit 94 is a motorized zoom lens in which a mobile element or elements are driven, relative to a stationary element or elements, by a zoom driver 108. The combined lens unit 96 also has a mobile element or elements, driven, relative to a stationary element or elements, by a zoom driver 108. The different zoom drivers 108 are coupled so as to zoom to the same extent, either mechanically (not shown) or by a controller 132 signaling the zoom drivers 108 to move the zoom elements of the units over the same or comparable ranges of focal lengths at the same time. The controller 132 can take the form of an appropriately configured microcomputer, such as an embedded microprocessor having RAM for data manipulation and general program execution.

The taking lens unit 94 of the embodiment of FIG. 3 is also autofocusing. An autofocusing system 110 has a sensor 112 that sends a signal to a ranger 114, which then operates a focus driver 116 to move one or more focusable elements (not separately illustrated) of the taking lens unit 94. The autofocus can be passive or active or a combination of the two.

The taking lens unit 94 can be simple, such as having a single focal length and manual focusing or a fixed focus, but this is not preferred. One or both of the viewfinder lens unit 100 and imager lens unit 98 can have a fixed focal length or one or both can zoom between different focal lengths. Digital zooming (enlargement of a digital image equivalent to optical zooming) can also be used instead of or in combination with optical zooming for the imager 84. The imager 84 and display 20 can be used as a viewfinder prior to image capture in place of or in combination with the optical viewfinder 88, as is commonly done with digital still cameras. This approach is not currently preferred, since battery usage is greatly increased.

Although the camera 14 can be used in other manners, the archival image is intended to provide the basis of the photofinished final image desired by the user and the verification image is intended to provide a check on the results that will be later provided in the final image. The verification image thus does not have to have the same quality as the archival image. As a result, with the camera 14 of FIG. 3, the imager 84 and the portion of the optical system 86 directing light to the imager 84 can be made smaller, simpler, and lighter. For example, the taking lens unit 94 can be focusable and the imager lens unit 98 can have a fixed focus or can focus over a different range or between a smaller number of focus positions.

A film shutter 118 shutters the light path 90 to the exposure frame 72. An imager shutter 120 shutters the light path 92 to the imager 84. Diaphragms/aperture plates 122, 124 can also be provided in both of the paths 90, 94. Each of the shutters 118, 120 is switchable between an open state and a closed state. The term “shutter” is used in a broad sense to refer to physical and/or logical elements that provide the function of allowing the passage of light along a light path to a filmstrip or imager for image capture and disallowing that passage at other times. “Shutter” is thus inclusive of, but not limited to, mechanical and electromechanical shutters of all types. “Shutter” is not inclusive of film transports and like mechanisms that simply move film or an imager in and out of the light path. “Shutter” is inclusive of computer software and hardware features of electronic array imagers that allow an imaging operation to be started and stopped under control of the camera controller 132.

In currently preferred embodiments, the film shutter 118 is mechanical or electromechanical and the imager shutter 120 is mechanical or electronic. The imager shutter 120 is illustrated by dashed lines to indicate both the position of a mechanical imager shutter 120 and the function of an electronic shutter. When using a CCD, electronic shuttering of the imager 84 can be provided by shifting the accumulated charge under a light shielded provides at a non-photosensitive region. This may be a full frame as in a frame transfer device CCD or a horizontal line in an interline transfer device CCD. Suitable devices and procedures are well known to those of skill in the art. When using a CID, the charge on each pixel is injected into a substrate at the beginning of the exposure. At the end of the exposure, the charge in each pixel is read. The difficulty encountered here is that the first pixel read has less exposure time than the last pixel read. The amount of difference is the time required to read the entire array. This may or may not be significant depending upon the total exposure time and the maximum time needed to read the entire array. CMOS imagers are commonly shuttered by a method called a rolling shutter. CMOS imagers using this method are not preferred, since this shutters each individual line to a common shutter time, but the exposure time for each line begins sequentially. This means that even with a short exposure time, moving objects will be distorted. Given horizontal motion, vertical features will image diagonally due to the temporal differences in the line-by-line exposure. Another method for shuttering CMOS imagers is described in U.S. Pat. No. 5,966,297. In this method, called single frame capture mode, all pixels are allowed to integrate charge during exposure time. At the end of the exposure time, all pixels are simultaneously transferred to the floating diffusion of the device. At this point sequential read out by lines is possible.

The imager 84 receives a light image (the subject image) and converts the light image to an analog electrical signal, an electronic image that is also referred to here as the initial verification image. (For convenience, the electronic image is generally discussed herein in the singular.) The electronic imager 84 is operated by the imager driver 126. The electronic image is ultimately transmitted to the image display 20, which is operated by an image display driver 128. Between the imager 84 and the image display 20 is a operation circuit 130.

The operation circuit 130 controls other components of the camera 10 and performs processing related to the electronic image. The operation circuit 130 shown in FIG. 3 includes a controller 132, an A/D converter 134, an image processor 136, and memory 138. Suitable components for the operation circuit are known to those of skill in the art. Modifications of the operation circuit 130 are practical, such as those described elsewhere herein. “Memory” refers to one or more suitably sized logical units of physical memory provided in semiconductor memory or magnetic memory, or the like. For example, the memory 138 can be an internal memory, such as a Flash EPROM memory, or alternately a removable memory, such as a Compact Flash card, or a combination of both. The controller 132 and image processor 136 can be controlled by software stored in the same physical memory that is used for image storage, but it is preferred that the processor 136 and controller 132 are controlled by firmware stored in dedicated memory, for example, in a ROM or EPROM firmware memory.

The initial electronic image is amplified and converted by an analog to digital (A/D) converter-amplifier 134 to a digital electronic image, which is then processed in the image processor 136 and stored in an image memory 138b. Signal lines, illustrated as a data bus 140, electronically connect the imager 84, controller 132, processor 136, the image display 20, and other electronic components.

The controller 132 includes a timing generator that supplies control signals for all electronic components in timing relationship. Calibration values for the individual camera 14 are stored in a calibration memory 138a, such as an EEPROM, and supplied to the controller 132. The controller 132 operates the drivers and memories, including the zoom drivers 108, focus driver 116, aperture drivers 142, and film and imager shutter drivers 144, 146.

The controller 132 connects to a flash arming circuit 148 that can assume an armed state, in which flash firing is allowed, and a disarmed state, in which flash firing is disallowed. The flash unit 64 has a flash firing circuit 149 which is connected to a strobe tube 151 that is mounted in a reflector 153. The flash firing circuit also includes and provides for charging of a flash capacitor (not shown). The features of the flash unit are not critical and a wide variety of different types, known to those of skill in the art, are suitable for use here.

It will be understood that the circuits shown and described can be modified in a variety of ways well known to those of skill in the art. It will also be understood that the various features described here in terms of physical circuits can be alternatively provided as firmware or software functions or a combination of the two. Likewise, components illustrated as separate units herein may be conveniently combined or shared in some embodiments.

The electronic verification images are accessed by the processor 136 and modified, as necessary, to meet predetermined output requirements, such as calibration to the display 20 used, and are output to the display 20. For example, the electronic image can be processed to provide color and tone correction and edge enhancement. The display 20 is driven by the image display driver 128 and, using the output of the processor 136, produces a display image that is viewed by the user. The controller 132 facilitates the transfers of the electronic image between the electronic components and provides other control functions, as necessary.

The operation circuit 130 also provides digital processing that calibrates the verification image to the display 20. The calibrating can include conversion of the electronic image to accommodate differences in characteristics of the different components. For example, a transform can be provided that modifies each image to accommodate the different capabilities in terms of gray scale, color gamut, and white point of the display 20 and imager 84 and other components of the electronic capture unit 16. The calibration relates to component characteristics and thus is invariant from image to image. The electronic image can also be modified in the same manner as in other digital cameras to enhance images. For example, the verification image can be processed by the image processor 136 to provide interpolation and edge enhancement. A limitation here is that the verification image exists to verify the archival image. Enhancements that improve or do not change the resemblance to the archival image are acceptable. Enhancements that decrease that resemblance are not acceptable. If the archival image is an electronic image, then comparable enhancements can be provided for both verification and archival images. A single electronic image can be calibrated before replication of a verification image, if desired. Digital processing of an electronic archival image can include modifications related to file transfer, such as, JPEG compression, and file formatting.

The calibrated digital image is further calibrated to match output characteristics of the selected photofinishing channel to provide a matched digital image. Photofinishing related adjustments assume foreknowledge of the photofinishing procedures that will be followed for a particular unit of capture media. This foreknowledge can be made available by limiting photofinishing options for a particular capture media unit or by standardizing all available photofinishing or by requiring the user to designate photofinishing choices prior to usage. This designation could then direct the usage of particular photofinishing options. The application of a designation on a capture media unit could be provided by a number of means known to those in the art, such as application of a magnetic or optical code. Difference adjustments can be applied anywhere in the electronic imaging chain within the camera 14. Where the difference adjustments are applied in a particular embodiment is largely a matter of convenience and the constraints imposed by other features of the camera 14.

The controller 132 can be provided as a single component or as multiple components of equivalent function in distributed locations. The same considerations apply to the processor 136 and other components. Likewise, components illustrated as separate units herein may be conveniently combined or shared in some embodiments.

Different types of image display 20 can be used. For example, the display 20 can be a liquid crystal display (“LCD”), a cathode ray tube display, or an organic electroluminescent display (“OELD”; also referred to as an organic light emitting display, “OLED”). It is also preferred that the image display 20 is operated on demand by actuation of a switch (not separately illustrated) and that the image display 20 is turned off by a timer or by initial depression of the shutter release 12. The timer can be provided as a function of the controller 132. The display 20 is preferably mounted on the back or top of the body 54, so as to be readily viewable by the photographer immediately following a picture taking. One or more information displays 150 can be provided on the body 54, to present camera 14 information to the photographer, such as exposures remaining, battery state, printing format (such as C, H, or P), flash state, and the like. The information display 150 is operated by an information display driver 152. Instead of an information display 150, this information can also be provided on the image display 20 as a superimposition on the image or alternately instead of the image (not illustrated).

The image display 20, as shown in FIG. 6, is mounted to the back of the body 54. An information display 150 is mounted to the body 54 adjacent the image display 20 so that the two displays form part of a single user interface 154 that can be viewed by the photographer in a single glance. The image display 20, and an information display 150, can be mounted instead or additionally so as to be viewable through the viewfinder 88 as a virtual display (not shown). The image display 20 can also be used instead of or in addition to an optical viewfinder 88.

It is preferred that the imager 84 captures and the image display 20 shows substantially the same geometric extent of the subject image as the latent image, since the photographer can verify only what is shown in the display 20. For this reason it is preferred that the display 20 show from 85-100 percent of the latent image, or more preferably from 95-100 percent of the latent image.

Referring now particularly to FIG. 3, the user interface 154 of the camera 14 has user controls 156 including “zoom in” and “zoom out” buttons 158 that control the zooming of the lens units, and the shutter release 12. The shutter release 12 operates both shutters 118, 120. To take a picture, the shutter release 12 is actuated by the user and trips from a set state to an intermediate state, and then to a released state. The shutter release 12 is typically actuated by pushing, and, for convenience the shutter release 12 is generally described herein in relation to a shutter button that is initially depressed through a “first stroke” (indicated in FIG. 3 by a solid lined arrow 160), to actuate a first switch 162 and alter the shutter release 12 from the set state to the intermediate state and is further depressed through a “second stroke” (indicated in FIG. 3 by a dashed lined arrow 164), to actuate a second switch 166 and alter the shutter release 12 from the intermediate state to the released state. Like other two stroke shutter releases well known in the art, the first stroke actuates automatic setting of exposure parameters, such as autofocus, autoexposure, and flash unit readying; and the second stroke actuates image capture.

Referring now to FIG. 3, when the shutter release 12 is pressed to the first stroke, the taking lens unit 94 and combined lens unit 96 are each autofocused to a detected subject distance based on subject distance data sent by the autoranging unit 114 (“ranger” in FIG. 3) to the controller 132. The controller 132 also receives data indicating what focal length the zoom lens units are set at from one or both of the zoom drivers 108 or a zoom sensor (not shown). The camera 14 also detects the film speed of the film cartridge 42 loaded into the camera 14 using a film unit detector 168 and relays this information to the controller 132. The camera 14 obtains scene brightness (Bv) from components, discussed below, that function as a light meter. The scene brightness and other exposure parameters are provided to an algorithm in the controller 132, which determines a focused distance, shutter speeds, apertures, and optionally a gain setting for amplification of the analog signal provided by the imager 84. Appropriate signals for these values are sent to the focus driver 116, film and imager aperture drivers 142, and film and imager shutter drivers 144, 146 via a motor driver interface (not shown) of the controller 132. The gain setting is sent to the A/D converter-amplifier 134.

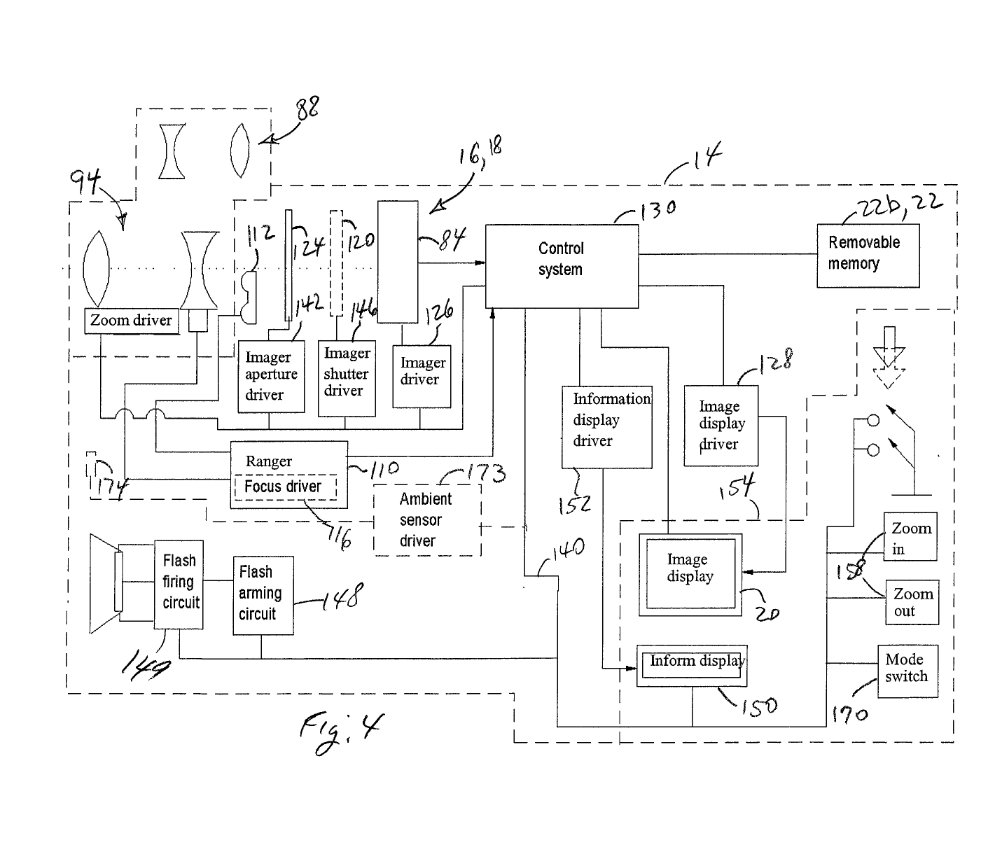

In the camera 14 shown in FIG. 3, the captured film image provides the archival image. In an alternative embodiment shown in FIG. 4, the archival image is an electronic image and the capture media is removable memory 22b. The type of removable memory used and the manner of information storage, such as optical or magnetic or electronic, is not critical. For example, the removable memory can be a floppy disc, a CD, a DVD, a tape cassette, or flash memory card or stick. In this embodiment, an electronic image is captured and then replicated. The first electronic image is used as the verification image. The second electronic image is stored on capture media to provide the archival image. The system 10, as shown in FIG. 2, is otherwise like the system 10 as earlier described, with the exception that photofinishing does not include chemical development and digitization. With a fully electronic camera 14, the verifying image can be a sampled, low resolution subset of the archival image or a second lower resolution electronic array imager (not illustrated) can be used.

The camera 14 shown in FIG. 5 allows use of either the film capture unit 18a or the electronic capture unit 16 as the archival capture unit, at the selection of the photographer or on the basis of available storage space in one or another capture media 22 or on some other basis. For example, the mode switch 170 can provide alternative film capture and electronic capture modes. The camera 14 otherwise operates in the same manner as the earlier described embodiments.

The camera 14 assesses an ambient illumination level and an ambient light color value corresponding to the color temperature of the scene illuminant using a ambient light discriminator 286, which includes the imager 84 and supporting circuitry or a separate detector 172 or both. (As a matter of convenience, the term “color detector” is sometimes used herein, in an inclusive sense, to refer both a separate detector 172 and an imager 84 and circuitry being used to assess a color value of ambient light.)

FIGS. 2-5 illustrate cameras 14 having an electronic imaging unit 16 including an imager 84, and an ambient detector 172 (indicated by dashed lines as being an optional feature). The detector 172 has an ambient detector driver 173 that operates a single sensor 174 or multiple sensors (not shown). The term “sensor” is inclusive of an array of sensors. Sensors are referred to here as being “single” or “multiple” based on whether the ambient light detection separately measures light received from different parts of the ambient area. A “single sensor” may have separate photodetectors for different colors. The ambient light sensor or sensors can receive light from the optical system 86 or can be illuminated external to the optical system 86.

The imager 84 can be used to determine color balance and the ambient detector 172 to determine scene brightness. (The imager 84 could be used for brightness and the ambient detector 172 for color balance, but this is not as advantageous.) Alternatively, either the imager 84 or the ambient detector 172 can be used to sense both values. The camera 14 can also be configured to change selectively change usage of the imager 84 and detector 172 with different user requirements, such as unusual lighting conditions.

Each approach has advantages and disadvantages. Use of the imager 84 reduces the complexity of the camera 14 in terms of number of parts, but increases complexity of the digital processing required for captured images. The imager 84 is shielded from direct illumination by overhead illuminants providing the ambient lighting. A detector 172 having a sensor or sensors receiving light from the optical system 86 has this same advantage. A separate detector 172 has the advantage of simpler digital processing and can divide up some functions. For example, a detector 172 can have a first ambient light detector to determine scene brightness for calculating exposure settings, prior to exposure and a second sensor to determine color value at the time of exposure (not shown). Use of the imager, reduces the number of parts in the camera 14. Information processing procedures for scene brightness and color balance can be combined for more efficient operations. This combination has the shortcoming of increasing the digital processing burden when only partial information is required, such as when exposure settings are needed prior to image exposure.

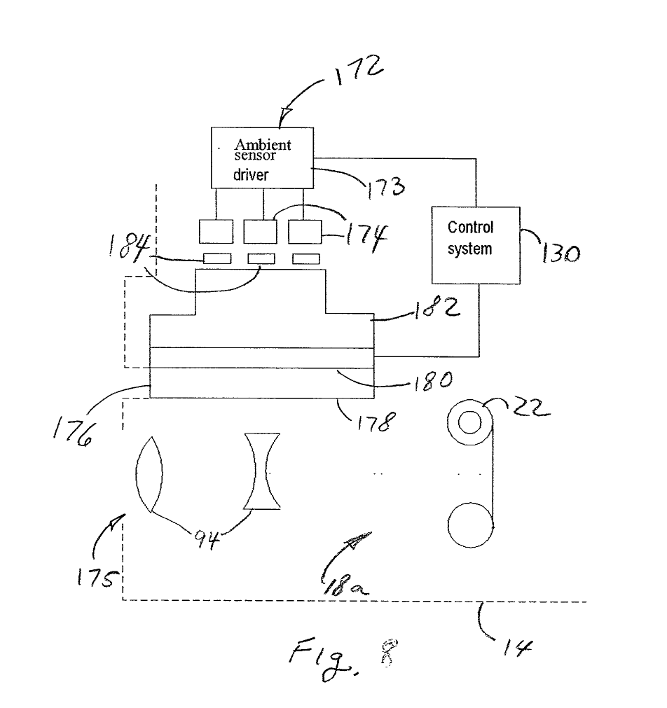

An example, of a suitable ambient detector that can be used to provide one or both of scene illumination and color value and is separate from the electronic image capture unit 16, is disclosed in U.S. Pat. No. 4,887,121, and is illustrated in FIG. 8. The detector 172 faces the same direction as the lens opening 175 of the taking lens unit 94 of the camera 14. The detector 172 receives light through a window 176 directed toward the scene image to be captured by the taking lens unit 94. Ambient light enters the window 176 and is directed by a first light pipe 178 to a liquid crystal mask 180. A second light pipe 182 receives light transmitted through the liquid crystal mask 180 and directs that light to a series of differently colored filters 184 (preferably red, green, and blue). A photodetector 186 located on the other side of each of the filters 184 is connected to the operation circuit 130. The liquid crystal mask 180 is controlled by the operation circuit 130 to transmit light uniformly to all of the photodetectors 186 for color measurement. The liquid crystal mask 180 provides a grid (not shown) that can be partially blocked in different manners to provide exposure measurements in different patterns.

The electronic capture unit 16 can be used instead of a separate detector 172, to obtain scene brightness and color balance values. In this approach, captured electronic image data is sampled and scene parameters are determined from that data. If autoexposure functions, such as automatic setting of shutter speeds and diaphragm settings, are to be used during that image capture, the electronic capture unit 16 needs to obtain an ambient illumination level prior to an image capture. This can be done by providing an evaluate mode and a capture mode for the electronic capture unit 16. In the evaluate mode, the electronic capture unit 16 captures a continuing sequence of electronic images. These images are captured, seratim, as long as the shutter release 12 is actuated through the first stroke and is maintained in that position. The electronic images could be saved to memory, but are ordinarily discarded, one after another, when the replacement electronic image is captured to reduce memory usage. The verification image is normally derived from one of this continuing series of electronic images, that is concurrent, within the limits of the camera shutters, with the archival image capture. In other words, the verification image is provided by the last of the series of electronic images captured prior to and concurrent with a picture taking event. Alternatively, one or more members of the sequence of evaluation images can be used, in place of or with the final electronic image, to provide photometric data for the exposure process as well as providing the data needed for color cast detection. The term “verification image” used herein, is inclusive of the images provided by either alternative; but, for convenience, the verification image is generally described herein as being derived from a final electronic image. The term “evaluation images” is used herein to identify the members of the series of electronic images that precede the capture of archival image and do not contribute or contribute only in part, to the verification image.

The evaluation images can be provided to the image display 20 for use by the photographer, prior to picture taking, in composing the picture. The evaluation images can be provided with or without a color cast signal. The provision of a color cast signal has the advantage that the photographer is given more information ahead of time and can better decide how to proceed. On the other hand, this increases energy demands and may provide information that is of little immediate use to the photographer while the photographer is occupied composing the picture. It is currently preferred that the camera 14 not display the evaluation images, since the use of the display 20 for this purpose greatly increases battery drain and an optical viewfinder 88 can provide an equivalent function with minimal battery drain.

For illumination levels, the electronic capture unit 16 is calibrated during assembly, to provide a measure of illumination levels, using a known illumination level and imager gain. The controller 132 can process the data presented in an evaluation image using the same kinds of light metering algorithms as are used for multiple spot light meters. The procedure is repeated for each succeeding evaluation image. Individual pixels or groups of pixels take the place of the individual sensors used in the multiple spot light meters. For example, the controller 132 can determine a peak illumination intensity for the image by comparing pixel to pixel until a maximum is found. Similarly, the controller 132 can determine an overall intensity that is an arithmetic average of all of the pixels of the image. Many of the metering algorithms provide an average or integrated value over only a portion of the imager 84 array. Another approach is to evaluate multiple areas and weigh the areas differently to provide an overall value. For example, in a center weighted system, center pixels are weighted more than peripheral pixels. The camera 14 can provide manual switching between different approaches, such as center weighted and spot metering. The camera 14 can alternatively, automatically choose a metering approach based on an evaluation of scene content. For example, an image having a broad horizontal bright area at the top can be interpreted as sky and given a particular weight relative to the remainder of the image.

Under moderate lighting conditions the imager 84 can provide light metering and color balance determination from a single evaluation image. More extreme lighting conditions can be accommodated by use of more than one member of a series of evaluation electronic images while varying exposure parameters until an acceptable electronic image has been captured. The manner in which the parameters are varied is not critical. The following approach is convenient. When an unknown scene is to be measured, the imager 84 is set to an intermediate gain and the image area of interest is sampled. If the pixels measure above some upper threshold value (T_{H}) such as 220, an assumption is made that the gain is too high and a second measurement is made with a gain of one-half of the initial measurement (1 stop less). (The values for T_{H} and T_{L} given here are by way of example and are based on 8 bits per pixel or a maximum numeric value of 255.) If the second measurement is one-half of the previous measurement, it is assumed that the measurement is accurate and representative. If the second measurement is still above T_{H}, the process is repeated until a measurement is obtained that has a value that is one-half that of the preceding measurement. If the initial measurement results in a value less than a low threshold (T_{L}) such as 45, the gain is doubled and a second measurement made. If the resultant measurement is twice the first measurement, it is assumed that the measurement is accurate and representative. If this is not the case, then the gain is doubled again and the measurement is repeated in the same manner as for the high threshold. Exposure parameters, such as aperture settings and shutter speeds can be varied in the same manner, separately or in combination with changes in gain. In limiting cases, such as full darkness, the electronic image capture unit 16 is unable to capture an acceptable image. In these cases, the evaluator can provide a failure signal to the user interface 154 to inform the user that the camera 14 cannot provide appropriate light metering and color balancing under the existing conditions. Appropriate algorithms and features for these approaches are well known to those of skill in the art.

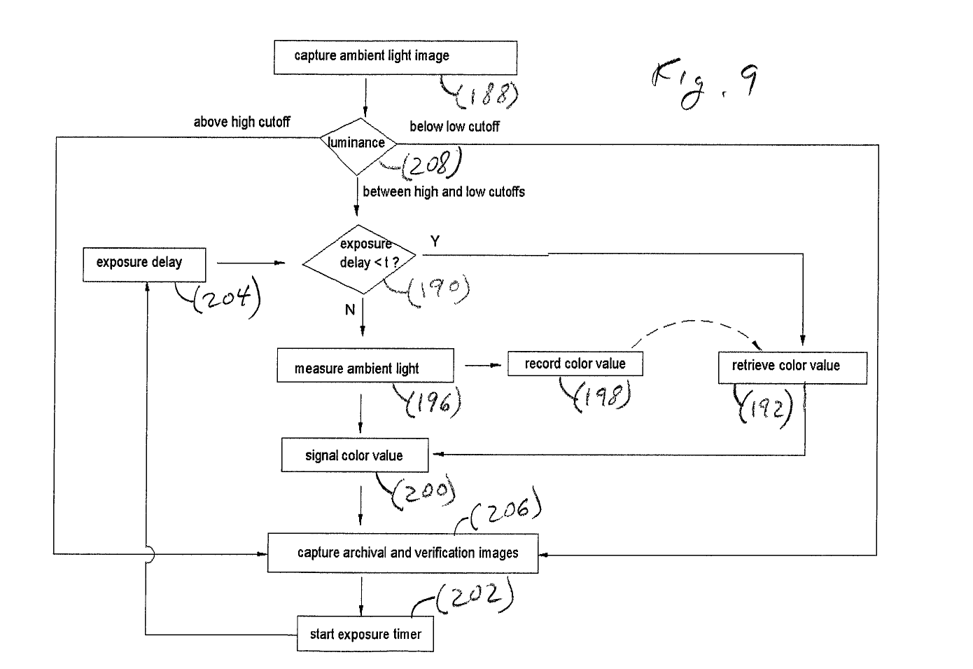

The cameras 14 can determine ambient illumination level and ambient light color value for every capture event. Alternatively, to save digital processing, the camera 14 can check for a recent exposure before measuring the ambient light or before performing all of the processing. Referring to FIG. 9,. for an image capture (188), if the camera 14 finds (190) a time elapse following an earlier exposure that is less than a predetermined value, the camera 14 retrieves (192) previously stored color value. If the time elapse is more than the predetermined value, then the camera measures (196) the ambient light and records (198) the resulting color value. The retrieved or assessed color value is signalled (200) to the controller. A timer is started (202) to provide the time elapse (204) for the next exposure and the verification image is displayed (206). The same procedure can be followed for the illumination level or for both the color value and the illumination level. The approach assumes that the ambient lighting will not change appreciably over a small elapsed time. Suitable elapsed time periods will depend upon camera usage, with longer times presenting a greater risk of error and shorter times increasing the processing burden on the camera during a series of exposures. For ordinary use, an elapsed time of less than a minute is preferred. The elapsed time timer is reset whenever the camera 14 is turned off.

Referring to FIG. 9, it is preferred that after the controller 132 receives the scene brightness value, the controller 132 compares (208) scene brightness to a flash trip point (also referred to as a low cutoff). If the light level is lower than the flash trip point, then the controller 132 signals the flash arming circuit 148 and enables full illumination by the flash unit 64, unless the user manually turned the flash off. With the flash unit already armed, the assessing of the scene illuminant color value and succeeding steps for determining flash arming can be skipped as being unnecessary. Flash units 64 provide an illuminant that approximates daylight and can be treated as providing daylight with most types of daylight balanced archival media. It is further preferred that after the controller 132 receives the scene brightness value, the controller 132 compares (208) scene brightness to a high cutoff. If the light level is higher than the high cutoff, then the controller 132 places the color detector in standby and archival image capture proceeds without a determination of scene illuminant color value. Due to the high luminance, the flash arming circuit 148 also remains in standby and the flash unit is not fired during capture of the archival image. This approach relies on an assumption that a very high illumination level is due to the camera being exposed to daylight illumination outdoors.

These approaches can be used with the elapsed time approach just discussed, as shown in FIG. 9. All of these secondary approaches can be implemented by software or firmware in the operation circuit (not separately illustrated) and can be combined into the other embodiments earlier discussed in any manner. The secondary approaches can also be modified, for example, by providing for the taking of color value and light level measurements every time and skipping only digital processing steps when the elapsed time or illumination conditions so warrant.

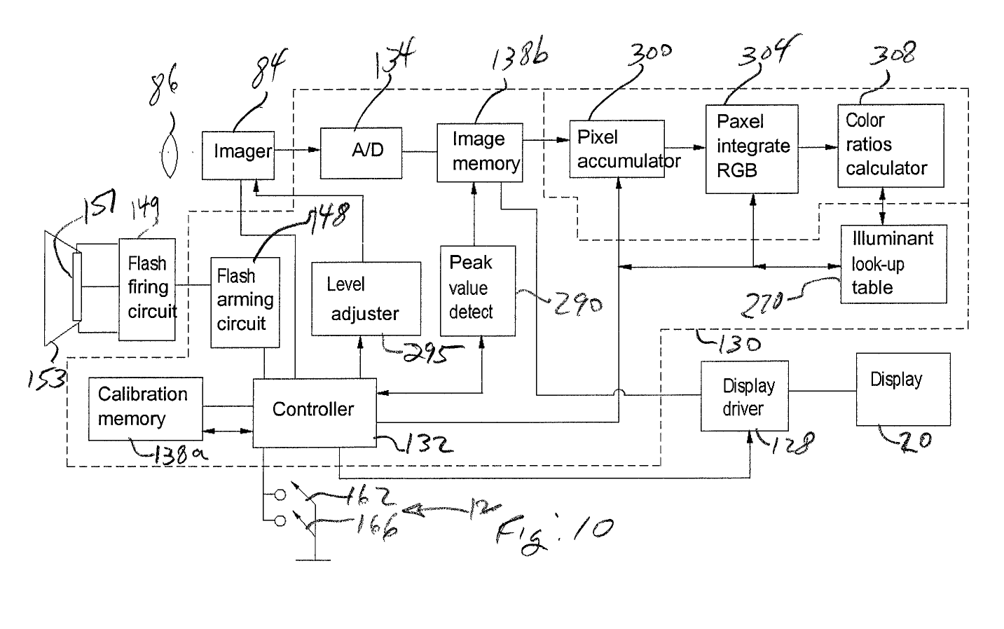

Referring now to FIG. 10, in a particular embodiment of the invention, the color detector is used (in this case an imager 84), with a look-up table 270, to categorize or classify the scene illuminant as matching to a color temperature range assigned to one of a set of predefined reference illuminants. The reference illuminants include a designated illuminant and one or more nondesignated illuminants. The designated illuminant is determined by the archival media. For example, for daylight type photographic film, the designated illuminant is daylight.

The number of different illuminants and combinations of illuminants compensated for depends upon the expected use of the camera 14. If the camera 14 is limited to daylight films (films having daylight as a designated illuminant) and ordinary consumer picture taking, compensation for a small number of illuminants is very acceptable. For most use, illuminants are limited to daylight, tungsten, and fluorescent. Fluorescent lighting is not a constant color temperature, but varies dependent upon the phosphors used in the tube. A number of different mixtures are commonly used and each has a characteristic color temperature, but none of the temperatures approach photographic daylight (correlated color temperature 6500° K). Tungsten lighting also varies similarly.

Fluorescent and tungsten lamps are available at a number of different correlated color temperatures and many types are standardized so as to provide uniform results. The camera 14 and method can be modified from what is described in detail here so as closely match as many different adaptive non-daylight illuminants as desired. For most use, the designated illuminant is daylight at a correlated color temperature of 6500 degrees Kelvin. Alternative designated illuminants can be provided, such as tungsten at a correlated color temperature of 2900 degrees Kelvin, to accommodate other types of film.

Full flash illumination is matched to the designated illuminant. This is convenient for daylight balanced archival media 22, since ordinary strobe tubes of flash units have a color temperature that does not present a color cast on daylight balanced media. Flash units having different output spectra would be required for other types of archival media, such as tungsten balanced photographic film.

When full flash is mandated by camera settings, the controller can send a flash-on signal to the look-up table 270 when the flash 64 is used. The flash-on signal overrides the color value signal from the color detector and, for daylight media, assigns daylight as the scene illuminant.

The ambient light discriminator provides a flash status signal to the flash firing circuit, which either arms the flash firing circuit or maintains the flash firing circuit in a stand by mode. This signal is sent through the operation circuit, which, for this purpose can be limited to a communication path. In that case, the operation circuit functions as a conduit. Alternatively, the flash status signal can be sent indirectly with the color value and luminance sent to the controller, which then provides the flash status signal to the flash firing circuit. Discussion here is generally directed to the latter. The flash status signal can be a single signal or color value and luminance can be signaled separately.

There are a number of different ways a color detector can determine the color temperature of a scene illuminant from a digital image of the scene. Different ways are going to reach the same conclusion in some cases, but may come to different conclusions as to the illuminant being used in other cases. The “gray world” approach says that in any given scene, if all of the colors are averaged together, the result will be gray, or devoid of chrominance. Departures from gray indicate a color cast. In a color detector of this type, the color determination can be made by arithmetically averaging together values for all the red, green, and blue pixels and comparing that result to ranges of values in the look-up table 270. The averaged color values for the scene are also sometimes referred to herein as a single “color temperature” of the scene. The dimensioned or dimensionless units chosen for color value are not critical, as long as the same system of units are used throughout the process or appropriate conversions are made as required. For example, the color value can be expressed as a correlated color temperature in degrees Kelvin or as a named illuminant that is characterized by such a color temperature, or as a gain adjustment for each of three color channels.

The gray world theory holds up very well on some scenes, but fails badly on others. An image of a white sandy beach with bright blue sky and ocean, for instance, will not average to gray. Likewise, an indoor scene with blue walls will not average to gray. These kinds of problem scenes can be dealt with by adding to the color determination steps directed to recognition of specific problem conditions. Due to these shortcomings, a color detector that uses the gray world approach is acceptable, but not preferred.

In an alternative “brightest objects” approach, it is assumed that the brightest objects in any scene, i.e., those with the highest luminance, are those most likely to be color neutral objects that reflect the scene illuminant. Pixels from the brightest objects are arithmetically averaged and compared to values in the look-up table 270. The brightest objects may be located by examining pixel values within the scene. A variety of different procedures can be used to determine which pixels to average. For example, the pixels can be a brightest percentage, such as five percent of the total number of pixels; or can be all the pixels that depart from an overall scene brightness by more than some percentage, such as all pixels having a brightness that is more than double the average brightness; or can be some combination, such as double average brightness pixels, but no more than five percent of the total pixels. In a particular embodiment, the pixels are combined into groups (paxels) by a pixel accumulator. An example of a typical paxel is a 36 by 24 block of pixels. The pixel accumulator averages the logarithmically quantized RGB digital values to provide an array of RGB paxel values for respective paxels.

When the above pixel measurements are made, if the pixel values are very high, the electronic imaging unit may be saturated. In this case, the gain of the electronic imaging unit is reduced and the scene is imaged again. The procedure is repeated until the values show a decrease proportional to the reduction in gain. This can be done in a variety of ways. In a particular embodiment having 8 bit pixels, when the brightest pixels have a value of 240, the gain is lowered by two and the scene is again imaged. The same pixels are examined again. If the value has decreased, this indicates that the imager 84 has not saturated and that the pixel data is valid. Once red (R), green (G), and blue (B) paxel values have been obtained and the pixel data has been determined to be valid, ratios of red value to blue value and green value to blue value can be calculated. These ratios correspond to a color value that is compared to the ranges in the look-up table 270.

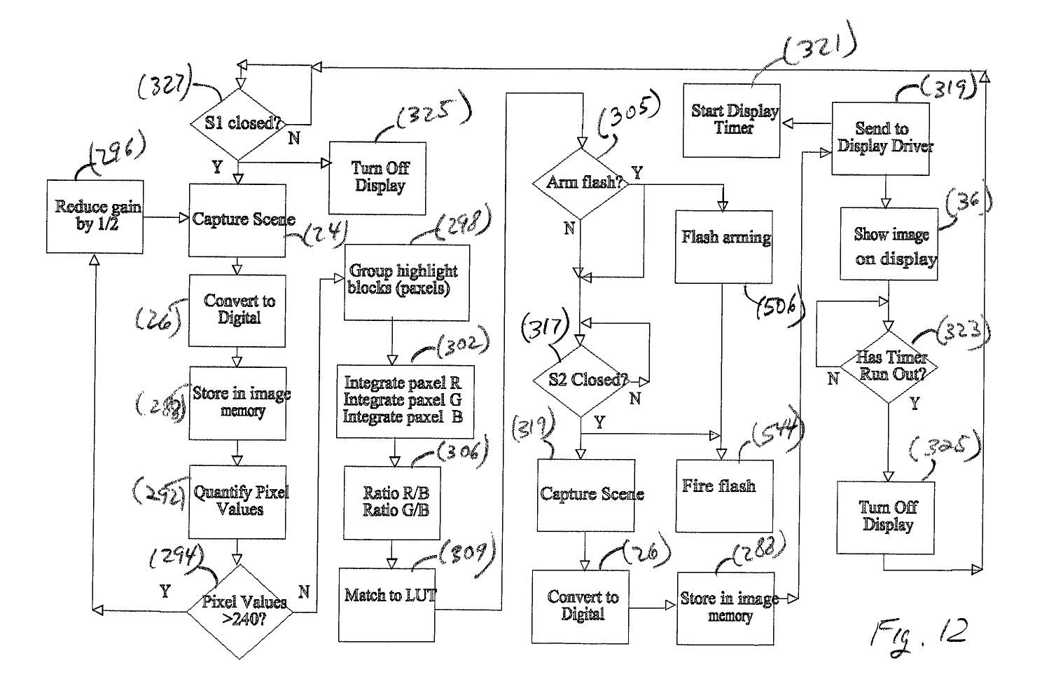

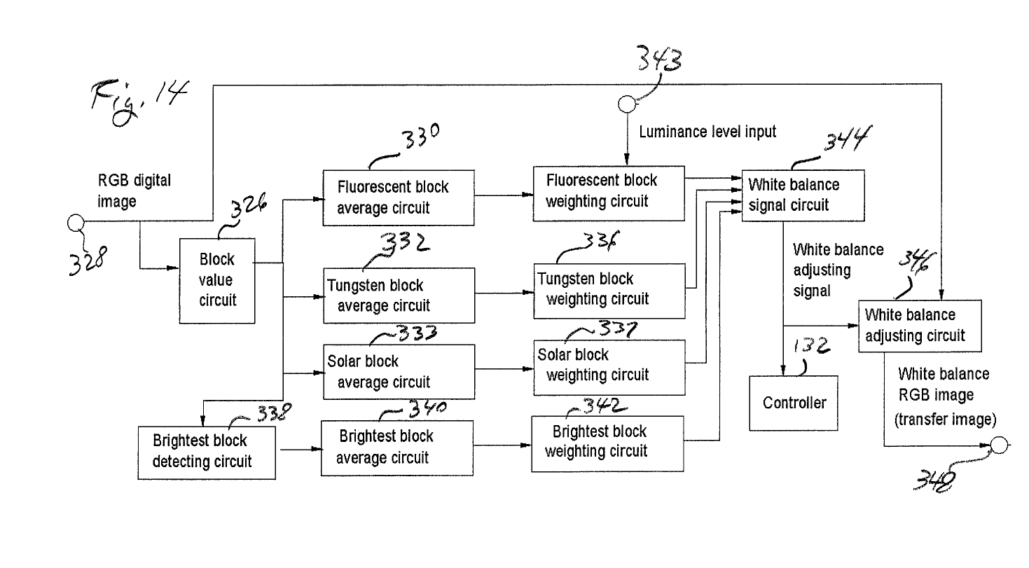

An example of a suitable “brightest objects” type color detector and its operation, are illustrated in FIGS. 12-16. After an electronic image is captured (24), digitized (26), and stored (288) in an image memory 289, a peak value detector 290 quantifies (292) the pixels and determines (294) highest pixel values. If values exceed a given threshold, for example, 240 in the example given above, a level adjuster 295 adjusts (296) the global gain of the electronic image unit 16 to a value of approximately one-half and the imager 84 captures (24) another image. This image is then converted (26) to digital and stored (288). The pixel data is again examined (292) by the peak value detector 290. If the peak value detector 290 determines (294) that peak values do not exceed the threshold, they are grouped (298) into highlights (paxels) by the pixel accumulator 300, as above discussed. If the peak values exceed the threshold the gain is again reduced and the process repeated until acceptable data is obtained. The paxels delineated by the pixel accumulator 300 are integrated (302) in red, green, and blue by the integrator 304 to provide integrated average values for red, green, and blue of the highlight areas of the image. These average values are combined (306) by the color ratios calculator 308 so as to calculate ratios of red to blue and green to blue in the ratio circuitry. These ratios provide a color value that is compared (309) to reference ranges in the look-up table 270.

Other “brightest objects” type color detectors 284 are available. For example, another suitable color detector of this type is disclosed in U.S. Pat, No. 5,659,357.

When the color value is fed from the color detector into to the look-up table 270 and compared to values in the table, the look-up table 270 matches the color value to values for a predetermined set of reference illuminants, including the designated illuminant and one or more non-designated illuminants. Scene illuminant color values in the look-up table 270 can be experimentally derived for a particular camera model by illuminating a neutral scene with standardized illuminants, recording the camera response, and calculating corrections.

The term “look-up table 270” refers to both a complement of logical memory in one or more computing devices and to necessary equipment and software for controlling and providing access to the logical memory. The look-up table 270 can have a stored set of precalculated final values or can generate values on demand from a stored algorithm or can combine these approaches. For convenience, the look-up table 270 is generally described here in terms of a store of precalculated values for the different scene illuminants. Like considerations apply to the other types of look-up table 270.

The values of the scene illuminants in the look-up table 270 can have a variety of forms, depending upon whether the values are arming or standby signals that are used to directly control the flash arming circuit 148 or are signals to an algorithm in the controller to generate the necessary arming and standby signals. In practice, use of one or the other is a matter of convenience and the constraints imposed by computational features of a particular camera 14 design.

For example, scene illuminant color value can be obtained from a white balancing circuit used as a color detector in the form of a white balance correction. The white balance correction can be precalculated for different reference illuminants relative to a designated illuminant and provided in the look-up table as scene illuminant color values. The white balance circuit is used, in this case, as a color detector in the same manner as earlier described, to provide color values for comparison to values in the look-up table. The look-up table assigns a range of small white balance corrections to the designated illuminant and matches larger corrections to other different ranges corresponding to a number of non-designated illuminants.

The scene illuminant values can be correlated color temperatures. The look-up table 270 correlates a range of color temperatures with each of the reference illuminants. These ranges can be derived by illuminating the verification imaging unit 16 of the camera 14 with a number of different sources for both fluorescent and tungsten (and daylight) and then combining the results for each.

A currently preferred approach is matching a range of scene illuminants to a small number of reference illuminants in the look-up table 270. One of the reference illuminants can be the designated illuminant and other reference illuminants commonly encountered types of light sources. For ordinary indoor and outdoor use, at least one reference illuminant in the look-up table should have a correlated color temperature of greater than 5000 degrees Kelvin and should have color values for daylight illumination assigned to it and at least one reference illuminant in the look-up table should have a correlated color temperature of less than 5000 degrees Kelvin. In a particular embodiment of the invention, the designated illuminant is daylight at a correlated color temperature of 6500 degrees Kelvin, and there are two non-designated illuminants: a fluorescent lamp at a correlated color temperature of 3500 degrees Kelvin and a tungsten lamp at a correlated color temperature of 2900 degrees Kelvin.

For example, in a particular embodiment, the camera 14 is used with daylight film (that is the designated illuminant is daylight) and there are two adaptive non-designated illuminants. The color detector functions as a colorimeter and outputs Commission Internationale de l'Eclairage (CIE) x, y chromaticity values. The look-up table 270 relates the x, y values to color temperatures as follows. Color values corresponding to color temperatures of 3500 to 4500 degrees Kelvin are matched to a CWF fluorescent illuminant at a correlated color temperature of 4500 degrees Kelvin, color values corresponding to color temperatures of less than 3500 degrees Kelvin are matched to a tungsten illuminant at a correlated color temperature of 2900 degrees Kelvin, and color values corresponding to color temperatures of greater than 4500 degrees Kelvin are matched to daylight at a correlated color temperature of 6500 degrees Kelvin. This is illustrated in Table 1 for common light sources.

TABLE 1

| | COLOR | | | ASSIGNED |
|---|---|---|---|---|
| LIGHT SOURCE | TEMP. | x | y | ILLUMINANT |
| average daylight | 6500 | 0.313 | 0.329 | Daylight at 6500 |
| Xenon Flash | 6000 | 0.326 | 0.333 | Daylight at 6500 |
| sunlight + skylight | 5500 | 0.334 | 0.347 | Daylight at 6500 |
| CWF fluorescent | 4500 | 0.362 | 0.364 | CWF fluorescent at 4500 |
| WF fluorescent | 3500 | 0.406 | 0.391 | CWF fluorescent at 4500 |
| WWF fluorescent | 3000 | 0.411 | 0.401 | CWF fluorescent at 4500 |
| tungsten 100 W | 2900 | 0.447 | 0.407 | Tungsten at 2900 |

In the just described approaches, color temperature ranges together map a continuous span of color temperatures. A discontinuous span can be provided instead, with missing ranges assigned to daylight or to a message (presented on the image display 20 or information display 150) that an approximate color balance cannot be shown in the verification image. Expected lighting conditions that have problematic color balances can be assigned as appropriate. For example, the expected scene color values for an outdoor image of green grass can be assigned to daylight.

The scene illuminant color values are generally described herein as correlated color temperatures of scene illuminants which are input into an algorithm that calculates required color values or other look-up table values. This description is intended as an aid in understanding the general features of the invention. It is also unnecessary to relate inputs provided by the color detector, in the form of RGB value ratios, or x, y values, or the like, to correlated color temperatures before deriving final color values. It is generally more efficient to precalculate so as to relate the scene illuminant color values to the required arming and standby signals for a particular camera 14 using a particular type of archival media 22.

The look-up table can incorporate adjustments for photofinishing color cast corrections or other adjustments by providing scene illuminant color values modified to accommodate the particular adjustment. For example, many photofinishing systems reduce a fluorescent color cast by about 80 percent. The scene illuminant color values could be modified to assume this reduction and not arm the flash unless the color cast after photofinishing was expected to be objectionable.

Referring to FIGS. 10 and 12, in a particular embodiment, the scene illuminant color values are sent from the look-up table 270 to the controller 132. In this embodiment, the controller 132 tests (305) whether the scene illuminant value requires the flash unit to be armed or retained in standby. If arming is required, a signal is sent to the flash arming circuit 148, which arms the flash firing circuit. In either case, the controller tests (317) if switch S2 166 is closed. When this occurs, verification and archival images of the scene are captured (319), and, if armed, the flash unit is fired by the flash firing circuit. The electronic image is converted (26) to digital form and stored (288) in the image memory 289. The resulting digital image is sent (319) to the display driver and then is shown (36) on the display as the verification image. The display timer is started (321). The controller tests (323) whether the timer has run out and, if so, turns off (325) the display. The controller also tests (327) if the first switch S2 162 is closed, if so, the timer is also turned off (325) and the cycle repeats for the next exposure.

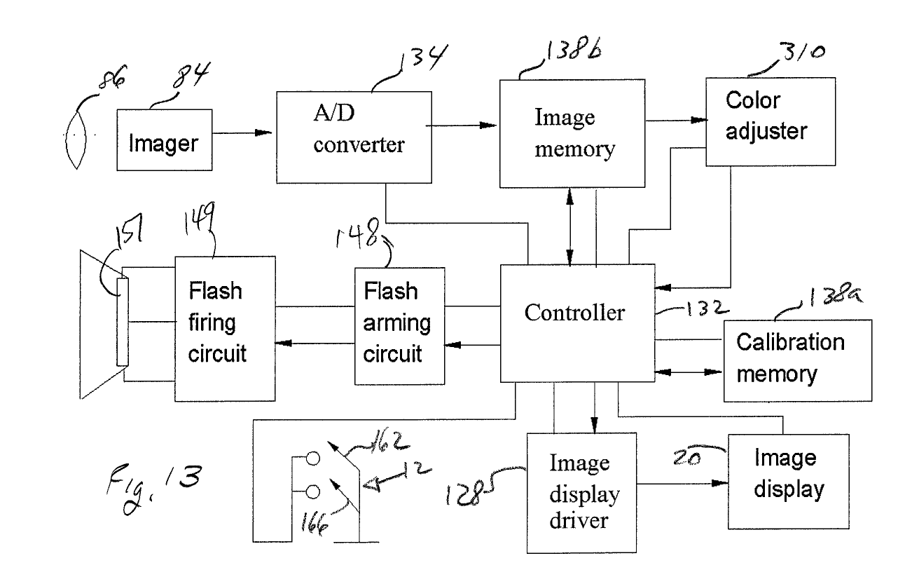

Referring now to FIGS. 13-16, in another embodiment, the camera 14 does not match a color value to a predetermined look-up table value. The camera 14 instead determines a color space vector that defines a color value in the form of a white balance correction. The white balance correction is relative to a neutral point for the archival storage media 22. Thus, if it were applied to the electronic image, the white balance correction would color balance the electronic image to the correlated color temperature for the a designated illuminant for the archival storage media 22, such that a gray subject has the color value of the neutral point (also referred to as “white point”) of the designated illuminant on a color space diagram. That gray subject would appear uncolored or white to a viewer visually adapted to the designated illuminant.

The magnitude, or magnitude and direction of the white balance correction color space vector, are conveyed to the controller as a scene illuminant color value. The color space vector can be expressed in a variety of forms, such as changes in correlated color temperature, or RGB ratios, or x, y values. A convenient form is as a combination of an Radj value and a Badj value as defined and calculated below (by definition Gadj does not change).

The controller arms the flash arming circuit 148 if the color space vector exceeds a particular magnitude, or exceeds a particular magnitude in a particular direction. An appropriate cut-off for flash arming can be determined by trial and error as to acceptable and unacceptable results obtained under different lighting conditions and particular archival media.

For example, arming can be provided when a white balance correction exceeds 2000 degrees Kelvin. This corresponds to the embodiment earlier discussed in relation to Table 1. The two approaches are similar. The white balance vector approach is in some ways simpler for well defined light sources, but more difficult for problem conditions such as outdoor photos of green grass.

Referring to FIG. 13, the ambient light discriminator includes a white balance circuit 322 (also referred to as a “white balancer 322”). The specific white balance circuit 322 used is not critical. A variety of white balance circuits are known to those of skill in the art, and can be used in the camera 14, taking into account computing power, memory requirements, energy usage, size constraints and the like. Many white balance circuits simply adjust the balance of the RGB code values so that an average represents an achromatic color. This approach is not preferred, since the color balancing should be for the scene illuminant, not the overall color balance including the scene content. Preferred white balance circuits assess the color of the scene illuminant.

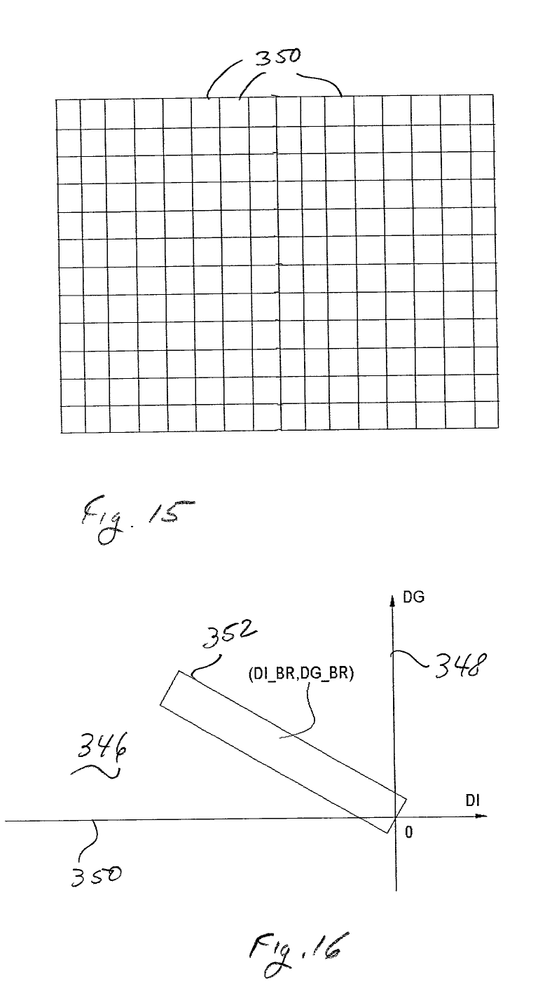

An example of a suitable white balance circuit of this type, is disclosed in U.S. Pat. No. 5,659,357. A similar circuit is shown in FIGS. 13-16. The white balance circuit 322 has a block representative value calculating circuit 326, into which an RGB digital image signal is inputted from an image signal input terminal 328. As shown in FIG. 15, the image signal is divided into a plurality of blocks 350 by the block representative value calculating circuit 326, then block representative values of the respective divided blocks are obtained. The blocks have a square shape and are regularly arranged according to a dividing method. The block representative value calculating circuit 326 obtains a value of the image signal included in the respective divided blocks as a block representative value. For example, an average value of the signals from all pixels (R, G, B) in the block is used as the representative value. An average value of the signals from the pixels sampled in the block, that from all pixels in a part of the block and a median or a mode of the image signal of the block can be used as the representative value.

The block representative values obtained by the block representative value calculating circuit 326 are processed in the fluorescent lamp block average value calculating circuit 330, the tungsten light block average value calculating circuit 332, the daylight light block average value calculating circuit 333, the brightest block searching circuit 338 and the brightest block average value calculating circuit 340 through predetermined procedures, respectively.

In a fluorescent lamp block average value calculating circuit 330, block representative values included in a fluorescent lamp white signal area are selected from among the block representative values obtained by the block representative value calculating circuit 326, and an average value and the number of the selected block representative values are obtained as a fluorescent lamp block average value and the number of fluorescent lamp blocks, respectively. The fluorescent lamp white signal area is defined as an area around which the image signals from white subjects irradiated by a fluorescent lamp are distributed. The fluorescent lamp block average value calculating circuit 330 counts the number of the selected block representative values to obtain the number of blocks the representative values of which are included in the fluorescent lamp white signal area (the number of fluorescent lamp blocks).

A tungsten light block average value calculating circuit 332 selects the block representative values belonging to a tungsten light white signal area from among all the block representative values, and obtains an average value of the selected block representative values (a tungsten light block average value) and the number of the selected blocks (the number of the tungsten light blocks). The tungsten light white signal area is defined as an area around which the image signals from white subjects irradiated by light of a tungsten lamp are distributed.

A daylight light block average value calculating circuit 333 selects the block representative values belonging to a daylight light white signal area from among all the block representative values, and obtains an average value of the selected block representative values (a daylight light block average value) and the number of the selected blocks (the number of the daylight light blocks). The daylight light white signal area is defined as an area around which the image signals from white subjects irradiated by daylight illumination are distributed.

The brightest block searching circuit 338 selects the brightest block of all the blocks in the image signal. The brightest block has the highest luminance of the blocks among which the R, G and B components of the block representative value indicate respective predetermined R, G and B threshold values or more. The brightest block searching circuit 338 outputs the representative value of the brightest block (the brightest block representative value). In a particular embodiment, the brightest block searching circuit 338 chooses the blocks the R, G, B components of which are larger than respective predetermined R, G and B threshold values, and selects a block having the highest luminance out of the chosen blocks as the brightest block in the image signal. The luminance L is defined by

L=(2*G+R+B)/4

or by

L=(6*G+3*R+B)/10

The luminance defined by an equation other than these above equations can be used. The brightest block searching circuit 338 outputs the representative value of the brightest block (the brightest block representative value) obtained by the selection to the brightest block average value calculating circuit 340.

The brightest block average value calculating circuit 340 obtains a brightest block signal area based on the brightest block representative values inputted from the brightest block searching circuit 338. An area around which the brightest block representative values of a predetermined color are distributed is defined as the brightest block signal area. A method for obtaining the brightest block signal area is described by reference to FIG. 16. An inputted brightest block representative value is plotted in the DG-DI plane 346. The values of DG 348 and DI 350 axes are defined by

DG=(2*G−R−B)/4 equation (a)

DI=(B−R)/2 equation (b)

The values (DI−BR, DG−BR) in the DG−DI plane 346 are calculated from the values of the R, G, and B components of the brightest block representative value by the equations (a) and (b). The line segment linking the origin and the point (DI−BR, DG−BR) is set in the DG-DI plane 346. A rectangular area 352 including the line segment and having sides parallel to the line segment is defined as the brightest block signal area (FIG. 5). In this example, the length of the sides parallel to the line segment linking the origin and the point (DI−BR, DG−BR) is predetermined times as long as that of the line segment and the length of the sides perpendicular to the line segment is predetermined. Both lengths can be determined by trial and error.

The brightest block average value calculating circuit 340 selects the block representative values included in the brightest block signal area from among the block representative values inputted from the block representative value calculating circuit 326, and obtains an average value of the selected block representative values (a brightest block average value) and the number of the selected blocks (the number of the brightest blocks).

A fluorescent lamp block weighting circuit 334 calculates a fluorescent lamp block weighting factor based on inputted data from the fluorescent block averaging circuit 330. The fluorescent lamp block weighing circuit 334 multiplies the fluorescent lamp block average value and the number of the fluorescent lamp blocks by the fluorescent lamp block weighting factor to obtain a weighted fluorescent lamp block average value and a weighted number of the fluorescent lamp blocks. A subject luminance is inputted from a subject luminance input terminal 343 to the fluorescent lamp block weighting circuit 334 when the fluorescent lamp block average value and the number of the fluorescent lamp blocks are inputted to the fluorescent lamp block weighting circuit 334 from the fluorescent lamp block average value calculating circuit 330.

The fluorescent lamp block weighting circuit 334 calculates a fluorescent lamp block weighting factor based on the inputted data through a predetermined procedure. A example of a method for calculating this weighting factor is described below, where the subject luminance is denoted as BV, the fluorescent lamp block average value as (R F, G F, B F) and a saturation of the fluorescent lamp block average value as S F. The saturation S is defined by

S=(DG*DG+DI*DI) equation (c)

The DI and DG values for the fluorescent lamp block average value (R F, G F, B F) is obtained by the equations (a) and (b). The S F can be obtained by applying the above obtained DI and DG values to the equation (c).

According to this weighting factor determining method, a smaller fluorescent lamp block weighting factor W F is set up when the subject luminance is higher in order to prevent the color failure arising out of a white subject irradiated by a fluorescent lamp and green grass in sun light. A high subject luminance indicates a bright subject, suggesting that the subject is in sunlight rather than irradiated by a fluorescent lamp. The image signals derived from green grass in sunlight are possibly included in the fluorescent lamp white signal area rather than those from a white subject irradiated by a fluorescent lamp. When the subject luminance is high, the effect of the white balance adjusting for the subject irradiated by a fluorescent lamp is required to be diminished by decreasing the fluorescent lamp block weighting factor, which weights the fluorescent lamp block average value, to a small value near zero. The fluorescent lamp block weighting factor can be determined using predetermined threshold values of BV0, BV1, BV2 and BV3 by the following rule:

(1) If BV<BV0, then W F=1.0

(2) If BV0≦BV<BV1, then W F=0.75

(3) If BV1≦BV<BV2, then W F=0.5

(4) If BV2≦BV<BV3, then W F=0.25

(5) If BV3≦BV, then W F=0.0 where BV0<BV1<BV2<BV3.

In the above rule, the W F is determined only based on the subject luminance BV. The essence of this determining method is to set the fluorescent lamp block weighting factor W F at a small value when the subject luminance BV is high, and to set at 1, irrespective of values of the subject luminance when the saturation is sufficiently small. In addition, the fluorescent lamp block weighting factor can be set at a small value, irrespective of values of the BV when the saturation S F is very large. Instead of the above rule, the S F can be obtained using a specific function f (R F, G F, B F) of the variable fluorescent lamp block average value and subject luminance BV.

The fluorescent lamp block weighting factor W F obtained by this method enables the following: When the subject luminance BV is low, which suggests that the subject is possibly irradiated by a fluorescent lamp, the white balance adjusting removes the effect of the illumination with a fluorescent lamp. When the subject luminance BV is high, which suggests that the subject is possibly green grass in the daylight light, the white balance adjusting relating to light of a fluorescent lamp is diminished.

The fluorescent lamp block weighting circuit 334 multiplies the fluorescent lamp block average value and the number of the fluorescent lamp blocks by the fluorescent lamp block weighting factor determined.

A tungsten light block weighting circuit 336 calculates a tungsten light weighting factor based on the tungsten light block average value inputted from the tungsten light block average value calculating circuit 332 through a predetermined procedure, and multiplies the tungsten light block average value and the number of the tungsten light blocks by the tungsten light weighting factor to obtain a weighted tungsten light block average value and a weighted number of the tungsten light blocks.

A daylight light block weighting circuit 337 calculates a daylight light weighting factor based on the daylight light block average value inputted from the daylight light block average value calculating circuit 333 through a predetermined procedure, and multiplies the daylight light block average value and the number of the daylight light blocks by the daylight light weighting factor to obtain a weighted daylight/tungsten light block average value and a weighted number of the daylight light blocks.

The brightest block average value and the number of the brightest blocks are inputted to a brightest block weighting circuit 342 from the brightest block average value calculating circuit 340. The brightest block weighting circuit 342 obtains a brightest block weighting factor based on the brightest block average value, and multiplies the brightest block average value and the number of the brightest blocks by the brightest block weighting factor to obtain a weighted brightest block average value and a weighted number of the brightest blocks.

The above explained circuits of the block average value calculating circuits 330, 332, 333 and the block weighting circuits 334, 336, 337 can be used for white balance adjusting; but it is preferred that the balancing also take into account brightest blocks by including the brightest block searching circuit 338, brightest block average value calculating circuit 340, and brightest block weighting circuit 342.

Daylight and tungsten light block average values are inputted to the daylight and tungsten light block weighting circuits 336, 337, respectively. The daylight and tungsten light block weighting circuits 336, 337 determine daylight and tungsten light block weighting factors, respectively, based on the inputted data through predetermined procedures. For example, the daylight or tungsten light block average value can be denoted as (R D, G D, B D), and a saturation of the daylight or tungsten light block average value as S D. The saturation S D is obtained by the equation (c), as the aforementioned S F. According to this determining method, the daylight or tungsten light block weighting factor W D is set at a small value when the S D is large.

Another method for determining the daylight and tungsten light block weighting factor W D can be adopted, rather than the above rule. For instance, W D can be obtained using a specific function f (R D, G D, B D) of the variable daylight or tungsten light block average value (R D, G D, B D) instead of the above rule using the S D. The daylight and tungsten light block weighting factors obtained according to this method prevents excessive adjustment of white balance when the human eye cannot be thoroughly adapted to the circumstances as in a sunset.

The tungsten light block weighting circuits 336 multiplies the tungsten light block average value and the number of the tungsten light blocks by the tungsten light block weighting factor determined and the daylight light block weighting circuits 337 multiplies the daylight light block average value and the number of the daylight light blocks by the daylight light block weighting factor determined.

A brightest block average value and the number of the brightest blocks are inputted to the brightest block weighting circuit 342 from the brightest block average value calculating circuit 340. The brightest block weighting circuit 342 obtains a brightest block weighting factor based on the inputted data through a predetermined procedure.

For example, the brightest block average value is denoted as (R B, G B, B B), and a saturation of the brightest block average value as S B. The saturation S B is obtained by the equation (c), as the S F. This method for determining the brightest block weighting factor W B is determined by the following rule using predetermined threshold values of S0 B, S1 B:

(1) If S B<S0 B, then W B=1.0

(2) IF S0 B≦S B and (B B≧R B or 2*G B−R B−B B≦0), then W B=0.0

(3) If S0 B<S B≦S1B and (B B<R B and 2*G B−R B−B B>0), then W B=1.0

(4) IF S1 B<S B and (B B<R B and 2*G B−R B−B B>0), then W B=0.75 where S0 B<S1 B.

In this rule, the brightest block weighting factor W B is set at zero when B B≧R B or 2*G B−R B−B B≦0. The brightest block representative value satisfying the described conditions suggests that the image is possibly derived from the blue sky. Under these conditions, the white balance adjusting using a brightest block weighting factor of unity, which strongly reflects on the state of the brightest block, easily causes the color failure. The above described is an example of the methods for determining the brightest block weighting factor. The brightest block weighting factor can be appropriately determined depending on the conditions of use, such as what light sources are mainly used, what subjects are mainly imaged.

The brightest block weighting circuit 342 multiplies the brightest block average value and the number of the brightest blocks by the weighting factor determined

A white balance adjusting signal calculating circuit 344 calculates a white balance adjusting signal based on the weighted values obtained by the fluorescent lamp block weighting circuit 334, the tungsten light block weighting circuit 336, the daylight light block weighting circuit 337, and the brightest block weighting circuit 342. The white balance adjusting signal calculating circuit 344 combines the weighted block average values proportionally to the ratio of the weighted numbers of the fluorescent lamp, daylight, and tungsten light and brightest blocks, and obtains the white balance adjusting signal based on the combined value. In this operation, a ratio of contribution of the fluorescent lamp, daylight, tungsten, and brightest blocks to the white balance adjusting signal (a ratio of combination) is first obtained by

M F=W F*CNT F/(W F*CNT F+W D*CNT D+W B*CNT B) equation (d)

M D=W F*CNT D/(W F*CNT F+W D*CNT D+W B*CNT B) equation (e)

M B=W F*CNT B/(W F*CNT F+W D*CNT D+W B*CNT B) equation (f)

where M F, M D and M B are ratios of combination of the fluorescent lamp blocks, the daylight/tungsten light blocks and the brightest blocks, respectively. CNT F, CNT D and CNT B are the numbers of the fluorescent lamp blocks, the daylight/tungsten light blocks and the brightest blocks, respectively. The W*CNT in each above equation is a weighted number of the blocks. The ratio of combination is a ratio of the weighted number of the blocks of a light source (one out of the fluorescent lamp, the daylight/tungsten light and the brightest light) to the number of all blocks.

A mixed signal (Rmix, Gmix, Bmix) is obtained based on the ratios of combination for the respective light sources by

Rmix=M F*R F+M D*R D+M B*R B equation (g)

Gmix=M F*G F+M D*G D+M B*G B equation (g)

Bmix=M F*B F+M D*B D+M B*B B equation (g)

The white balance adjusting signals of Radj and Badj are obtained based on the three components of the mixed signal by

Radj=Gmix−Rmix

Badj=Gmix−Bmix

Instead of using the above mentioned Radj and Badj, MAX-Ramix, MAX-Gmix and MAX-Bmix can be used as the white balance adjusting signals after obtaining MAX=max (Rmix, Gmix, Bmix). The operator max (a, b, . . . ) means selecting a maximum value out of all values in the parentheses.

In this embodiment, the white balance adjusting can be influenced by the image signal information of the brightest block. Consequently, the white balance adjusting signal can be appropriately determined for an image derived from a subject irradiated by a light source other than predetermined ones.

A photofinishing color cast correction or other adjustment can be added to the color adjusting, that is, the scene illuminant color values, by changing the white balance adjusting signal or modifying one of the steps in the calculation of that signal. As is the case in the other embodiments described, such modifications can be accommodated by assigning a standard adjustment to all of the determinations or a variable adjustment can be provided. For example, an appropriate look-up table can be provided for the different adjustments. Such a look-up table can use input as to film type, color value, and the like to provide different photofinishing color cast reductions or other adjustments. Input can be manual or can use a film sensor or a combination of the two. For example, some photofinishing processes provide an eighty percent reduction in color cast, but no change in hue of the remaining color cast, in photofinished images from color negative film. This can be accommodated, in the camera, by calculating an eighty percent reduction in the white balance correction and applying this modification, whenever color negative film is used in the camera, or at all times.

In the embodiment shown, an optional auto white balance adjusting circuit 346 adjusts the white balance for an inputted image signal using the white balance adjusting signal. The resulting white balance adjusted RGB image, that is, the transfer image, is outputted from a white balanced image signal output terminal 358. The transfer image can be output as an electronic file for use in electronic mail or other digital use. The auto white balance adjusting circuit 346 applies the white balance adjusting signals to the R and B components of all image pixels, respectively in order to adjust the white balance and thus provide a transfer image for later electronic transfer. This copy can be displayed, if desired, and can be modified in the manner of other digital images used for electronic mail and other electronic transfer. For example, the electronic image can be stored as a compressed file in a particular format, such as an Exif/JPEG image file. If desired, the white balance correction parameters may be stored with the share image to allow reconversion to the non-balanced image.

The invention has been described in detail with particular reference to certain preferred embodiments thereof, but it will be understood that variations and modifications can be effected within the spirit and scope of the invention.

What is claimed is:

1. A photographic apparatus for use in ambient light with an archival capture media having a designated illuminant, said apparatus comprising:
a body;
an ambient light discriminator mounted in said body, said discriminator assessing a color value of said ambient light;
a flash firing circuit disposed in said body; and
a operation circuit operatively connecting said ambient light discriminator and said flash firing circuit, said flash firing circuit arming responsive to a mismatch between said color value and said designated illuminant.

2. The apparatus of claim 1 wherein said archival capture media is photographic film, said designated illuminant is daylight, said color value is a chromaticity, and said apparatus further comprises a film image capture unit.

3. The apparatus of claim 1 wherein said ambient light discriminator includes a look-up table having scene illuminant values of a plurality of reference illuminants and said operation circuit compares said color value to said reference illuminants.

4. The apparatus of claim 1 wherein said ambient light discriminator includes a white balancing circuit and said color value is a vector white balancing correction.

5. The apparatus of claim 1 wherein said ambient light discriminator includes a brightest objects type color detector.

6. A camera for use with archival media having a designated illuminant, said camera comprising:
a body;
an ambient light discriminator mounted in said body, said ambient light discriminator assessing a color value and brightness of said ambient light;
a flash arming circuit disposed in said body;
a operation circuit operatively connecting said ambient light discriminator and said flash arming circuit, said ambient light discriminator and operation circuit actuating said flash firing circuit responsive to at least one of:
a mismatch between said color value and said designated illuminant and
said brightness being less than a predetermined level.

7. The camera of claim 6 further comprising an image capture unit.

8. The camera of claim 6 wherein said archival capture media is photographic film, said designated illuminant is daylight, said color value is a chromaticity, and said camera further comprises a film image capture unit.

9. The camera of claim 8 further comprising an electronic array imager disposed in said body.

10. The camera of claim 9 further comprising a display unit operatively connected to said electronic imager and said operation circuit.

11. The camera of claim 6 wherein said ambient light discriminator includes a look-up table having scene illuminant values of a plurality of reference illuminants and said operation circuit compares said color value to said reference illuminants.

12. The camera of claim 6 wherein said ambient light discriminator includes a white balancing circuit and said color value is a vector white balancing correction.

13. A flash-assisted image capture method for use in ambient light, said method comprising the steps of:
assessing a color value of said ambient light;
arming a flash firing circuit when said color value is outside a predetermined color value range.

14. A flash-assisted image capture method comprising the steps of:
capturing an ambient light image as an electronic image in a camera;
assessing a illuminant color value of said ambient light image;
comparing said illuminant color value to a predetermined color value range;
arming a flash firing circuit when said illuminant color value is outside said predetermined color value range.

15. The method of claim 14 further comprising capturing an archival image following said arming.

16. The method of claim 15 further comprising actuating said flash firing circuit during said capturing.

17. The method of claim 14 further comprising assessing luminance concurrent with said assessing of said illuminant color value; comparing said luminance to a predetermined luminance range; and arming a flash firing circuit when said luminance is outside said predetermined luminance range.

18. A flash-assisted image capture method comprising the steps of:
assessing a color value of ambient light;
arming a flash firing circuit responsive to a mismatch between said color value and a designated illuminant;
capturing a latent film image on photographic film color balanced for said designated illuminant;
firing a flash unit during said capturing.

19. The method of claim 18 wherein said assessing further comprises capturing an electronic image.

20. The method of claim 19 wherein said assessing further comprises comparing said color value to a look-up table of reference illuminants.

21. The method of claim 19 wherein said assessing further comprises determining a white balance correction vector from said color value to a neutral point for said designated illuminant.

22. The method of claim 18 wherein said assessing further comprises comparing said color value to a look-up table of reference illuminants.

23. The method of claim 18 wherein said assessing further comprises determining a white balance correction vector from said color value to a neutral point for said designated illuminant.

24. The method of claim 18 wherein said color value is a chromaticity.
